(19) United States
(12) Patent Application Publication
(10) Pub. No.: US 2014/0279352 A1
(43) Pub. Date: Sep. 18, 2014

(54) SYSTEM AND METHODS OF PROVIDING A FUNGIBLE CONSUMER SERVICES MARKETPLACE

(71) Applicants: Stuart Schaefer, Sammamish, WA (US); Eric Voskuil, Kirkland, WA (US); Phillip Mienk, Redmond, WA (US); Leonard Charest, Redmond, WA (US); Bryan Garrestson, Kent, WA (US)

(72) Inventors: Stuart Schaefer, Sammamish, WA (US); Eric Voskuil, Kirkland, WA (US); Phillip Mienk, Redmond, WA (US); Leonard Charest, Redmond, WA (US); Bryan Garrestson, Kent, WA (US)

(21) Appl. No.: 13/845,933

(22) Filed: Mar. 18, 2013

(51) Int. Cl. G06Q 40/04

(52) U.S. Cl. CPC G06Q 40/04
USPC 705/37

(57) ABSTRACT

The invention generally pertains to computer software and methods, and more generally pertains a system for, and methods of providing, a fungible services marketplace. The system and methods are useful in providing markets for consumer services.

### 1 PRIORITY

This application claims priority to U.S. provisional application Ser. No. 61/611,668 filed 16 Mar. 2012.

### 2 COPYRIGHT NOTICE

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright 2012, Shingl, Inc.

### 3 BACKGROUND

3.1 Technical Field

The technical field generally relates to computer software and systems. More specifically, the technical field relates to software and systems that provide a marketplace for the securitization of fungible services.

3.2 The Related Art and Background

In general terms, a market is any mechanism that allows people to buy and sell items of tangible value. For a market to be effective, it must set down transparent terms and rules for its participants, and the mechanisms of enforcement must be clearly presented. Terms can take various forms such as the types of items that are allowed in the market, transaction specifications, transaction fees, opening and closing times of the market itself, etc.

A market attracts interested parties to participate, facilitating the introduction and close of a transaction. Markets traditionally provide this capability by clearing or approving all transactions, ensuring that what is sold is substantially what was purchased. Automated markets require that the goods or services transacted in the market are fungible. Fungibility is an attribute that describes how effectively any unit of the goods and commodities being sold in the market can be replaced by another of the same type and apparent quality. Absent fungibility, each individual transaction is unique. Automated markets are not effective in an environment absent fungibility. Once market offerings are fungible, in theory, it does not matter to either participant who is buying or selling the item. Only the perceived value of the goods and services remains important.

Attempts at automated “markets” for goods and highly specialized services have been tried before (e.g. FreeMarkets). These systems provided fungibility at a high cost of specifying the items being sold in the market; in essence, they were consulting engagements that reduced non-fungible descriptions to well-specified purchase requests (e.g. to normalize quality and scope), and then operated a market mechanism to clear the normalized items based upon price. Consumer-procured services typically have such low value as to make creating a detailed level of specification impractical from a cost standpoint; the cost of the detail specification outweighs the value of these services, or the amount of work required to create the detailed specifications deters their creation. Automated mechanisms for normalizing proposals are needed for an automated consumer services marketplace to succeed.

Current approaches for matching proposals are inefficient, and often provide skewed results. Part of this is a result of a lack of specification as described above. Others issues arise from a lack of sourcing for customers and providers, lack of verification of parties and their ability to fulfill, etc. These approaches result in additional time, risk, cost, and effort being required by all those involved; more than is desirable.

Typically, service providers must spend money up-front for advertising and other forms of lead generation, while service consumers must spend time and effort researching providers. Thus, many contacts do not result in sales for various reasons, such as price, scheduling, or lack of trust that the service will be provided adequately, or that if provided, that the transaction will be completed to each party's satisfaction.

Service consumers make requests in non-standard ways, which make it hard for service providers to understand and provide quotes. Providers also make offers in terms that are unclear to the consumer. For example, a consumer's lawn mowing request often does not provide information about the size of the lawn to be mowed, or describes it vaguely using terms such as “large” or “small”. Even if information is provided, there is no way for a new service provider to easily verify the information. This often requires site visits from service providers before a job can be quoted. This is inefficient and increases the overhead costs of providers and the time invested by consumers to fill their own request. Automated means of translating vague descriptions to concise specifications are required.

For reasons such as these, markets for such things as shares of goods, companies, commodities, and financial instruments have existed for decades, while effective markets for consumer services have been lacking. Issues such as how to define services so that they are fungible, how to compare costs of services that charge using different pricing schemes, and how to determine the quality of a service must be addressed to make a consumer services marketplace possible.

Other existing systems provide matching services that claim to provide efficient markets. These systems suffer from a number of issues that hinder their use for transacting services. For one, they match on a limited number of factors, such as only price or schedule. Generally, they complete a transaction with the first match that occurs, without regard to whether there are “better” matches immediately available or that are likely to occur based upon existing and expected future market liquidity. This is referred to as “greedy matching”. Greedy matching increases the risk of inappropriate matches or matches that are not optimized for both participants. Instead of efficiency, these markets actually attempt to capture the maximum potential transaction value given current liquidity, which traditionally causes higher volatility. In a consumer services marketplace, high volatility reduces the confidence of consumers and service providers and lowers their willingness to participate.

There are also numerous problems associated with sourcing and liquidity that are currently unaddressed by today's market-based systems. Normally, liquidity is driven into a market from external sources such as market makers or other offline mechanisms to incent participants. In the presence of sufficient liquidity, speculation further drives additional participation. Otherwise, markets rely on their ability to manually drive interest in their system or in the securities being exchanged. Many market-driven approaches to problems fail due to their inability to drive sufficient liquidity into their systems on the whole or on the spot. Effective solutions to this problem are lacking.

The matching of service providers to consumers is based upon a number of other factors including availability, physical location, capability (skills, training, available equipment), reputation, and cost to perform the service. There are not automated mechanisms for managing most of these aspects of the transaction. In particular, there are not automated means for verifying provider-supplied information and keeping the verified information updated automatically. For example, a service provider may have insurance today and drop that insurance tomorrow. Similarly, licensure status may change over time.

Similarly, the matching of consumers to service providers is based upon a number of factors, including the consumer's availability, ability and willingness to pay, reputation, and job site location. There are not automated systems for managing these aspects of the transaction; in most cases the provider goes into a transaction with a consumer blind to whether the consumer has a history of not paying their providers or whether their existing providers are happy to do business with them again, for example. Automated mechanisms for extending and monitoring providers' and consumers' information, and for including it in marketplace matching activities, are needed to facilitate automated markets of consumer services.

A common problem with today's systems is that they focus on a referral model, e.g. they are the trusted provider of information to consumers about providers. This model has numerous challenges; including random quality of services provided, “shill” recommendations, incomplete or minimal verification of provider and/or consumer, etc. Other issues include a lack of selection in providers; that “good” providers are relatively busy and do not use referral services, while the new providers and those with poor reputations are the providers being referred.

Both consumers and service providers accrete reputation information that may influence whether others want to do business with them. Reputation earned through business dealings is not commonly portable and is subject to bias and fraud, and is currently not integrated with matching of consumers, their requests, and service providers. Similarly, the reputation that one has within a social network is also important, but is not accounted for within current service markets. A more effective reputation mechanism is needed.

There also is not a common mechanism by which consumers and providers can coordinate the scheduling of a service for fulfillment. Service providers and consumers are often time constrained. In some cases, the lack of availability is enough to cause a consumer to look elsewhere for other providers, or to request a large number of quotes in an attempt to find a provider who has reasonable prices and is available to perform the desired service. Typically, the coordination of schedules is handled manually for lack of automated mechanisms. For example, each service consumer needs to provide the service provider's information related to their availability (for example, if access to a consumer's premise is required). Similarly, service providers need to track their scheduling and manage notifications to consumers if they are running late to appointments. Current solutions to these issues are manual, vary greatly between providers and consumers, and are not scalable.

There are existing systems that bear some resemblance to various aspects of the system described herein, but none provide all aspects, and some aspects are missing entirely. For example, search engines can be used to locate providers of specific services; however, these have only weak reputation services (typically consisting of un-vetted and not necessarily representative participant reviews), directory-like listings with fee-based placement preference, and mapping integration. They lack business services, automatic matching, social networking weighting, and other aspects of the system. Another example is reputation providers. These specialize in directly vetting and thereby vouching for the reputations of service providers listed within their sites, and do not otherwise become involved in transactions. Examples include ServiceMagic, and Angie's List. Yet another example is the targeted marketplace, which is limited to services for specific business categories, such as freelance software developers (Guru.com, eFreeLance), home contracting (OfferABuilder), or maid services (OfferMyCleaning).

A general services marketplace system that can match consumer project requests with suitable service providers that are able fulfill these requests subject to specific terms and conditions is required.

### 4 BRIEF DESCRIPTION OF THE DRAWINGS

The features of the marketplace will best be understood its detailed description and example implementations thereof selected for the purposes of illustration and shown in the accompanying drawings in which:

FIG. 1 depicts the exemplary relationships between consumers, producers, and a services marketplace.

FIG. 2 illustrates a timing diagram for a proposal in a services marketplace system.

FIG. 3 illustrates a state diagram of a proposal in a services marketplace system.

FIG. 4 depicts an exemplary schematic diagram of a proposal in a Service Marketplace.

FIG. 5 depicts an exemplary schematic diagram of a Service Marketplace.

FIG. 6 is a flowchart of a Service Marketplace's Provider sourcing process.

FIG. 7 depicts an exemplary schematic diagram of a Consumer agent component of a Service Marketplace.

FIG. 8 depicts an exemplary schematic diagram of a Provider agent component of a Service Marketplace.

FIG. 9 is a flowchart of a Service Marketplace's order to offer matching process.

FIG. 10 is a flowchart of a Service Marketplace's proposal matching process.

FIG. 11 is a flowchart of a Service Marketplace's Consumer agent component process.

FIG. 12 is a flowchart of a Service Marketplace's Provider agent component process.

### 5 DESCRIPTION OF SOME IMPLEMENTATIONS OF THE MARKETPLACE

### 5.1 Overview

Over the past decade, markets for consumer goods have been reshaped by the Internet. However, the market for consumer services has not yet experienced this transformation. The consumer suffers from a comparable lack of transparency in price, quality, and choice. At the same time, service sourcing is dominated by costly advertising and labor-intensive search and verification, followed by inefficient servicing and processing.

The described system saves time for both the consumer and the service provider. It is a lengthy process today for a consumer to locate, validate, select, and engage with a service provider. Conversely, the overhead and difficulty of maintaining steady projects through marketing, word of mouth, and other traditional means leaves many small service providers with few choices on how to effectively grow their business.

Service providers use the system to close business, transact service agreements, and record the completion of transacted service agreements. It is important to make it easy for them to integrate their existing electronic systems such as calendars, consumer information-bases, and existing social and business networks with the system. Integrating these aspects of a service provider's business enables small businesses to derive significant benefits from a market-driven approach for locating and managing business.

The system described herein provides a fungible consumer services marketplace that enables participants to utilize automated mechanisms for sourcing, procuring, and managing the provision of consumer services. Consumer services are those services that are primarily personal in nature, such as lawn mowing, babysitting, plumbing, and the like. Participants are able to “push a button” in order to obtain or provide consumer services, and the mechanics of service definition, sourcing, scheduling, and other minutia surrounding arranging for the service to be performed are provided on behalf of each participant. Consumers and service providers both benefit from the time savings.

Traditional market-based systems require liquidity to achieve efficient pricing. Though the system frequently offers better pricing and lower risk for participants, time savings are a significant incentive to drive liquidity, in the form of a sufficiency of proposals to enable matching of offers and orders, into the system. With liquidity comes more efficient pricing and valuable marketplace data. Performance of the system improves with transaction volume, but the system does not have to guarantee low price to be effective. Unlike traditional market-based systems, the system described herein continues to operate efficiently in conditions with low liquidity and takes automatic actions to improve liquidity when needed.

One aspect of the system is that it treats proposals for consumer services as fungible items. This enables several new types of service contracting structures. First is service aggregation, where a group of Providers can aggregate their services in order to fulfill larger or more complex projects. The corollary to that is where a plurality of Consumers aggregates their requests in order to create a bigger, more attractive project. Second is service re-sourcing. Re-sourcing is where a Provider has “won” a contract for a particular project but is unable to fulfill on the project for some reason and needs to find another Provider to take their place. The Provider, using the system, can exchange their existing contract with another Provider for fulfillment, either pocketing the profit or covering any discrepancy. Conversely, a Consumer can re-source a services agreement to another Consumer if they no longer want the service for which they have contracted.

A fungible consumer services marketplace can be modeled as a multi-actor system. A Consumer interacts with the marketplace to enter orders, accept offers, and acknowledge completion of contracts. A Provider presents offers to the marketplace, accepts contracts, and notifies the system of service completion. The system acts as a trusted broker of proposals between Consumers and Providers. It normalizes proposals (e.g. offers and orders), defines quality of service, performs matching between proposals, defines contracts resulting from the match of proposals, tracks contract status, and assists with proposal change management, dispute resolution, and payment for completed contracts. By doing so, the market connects Consumers with Providers for the provision of fungible consumer services, while providing supporting services to speed and simplify the processes necessary to carry out transactions. The system is described as having two parts, a provider portion and a consumer portion. In some implementations, the operation of these disparate portions is symmetric and may be implemented using common components. For example, the Consumer and Provider profiles may be managed together as participant profiles, the order and offer managers may be implemented as a single proposal manager, etc. without detracting from the usefulness of the system. Any aspect of the Consumer/Order portion may be implemented for Providers/Offers, and vice-versa. The distinction between the Consumer and Provider portions of the system is presented here for clarity.

The marketplace provided by the system is generally opaque to its participants. There are no listings of Providers shown to Consumers, or Consumers to Providers, and there is no equivalent listing of current individual orders or offers to shown to either party. Thus, the system is not an auction, where parties bid on known contracts. Similarly, the system is not an OTC market, where bids and asks are made available to market participants as part of the operation of the market. The system is instead a demand market characterized by participants bidding on the existence of supply from counterparties with the market providing stability by helping to balance demand. For example, a Consumer makes an order for a service with the belief that the system will be able to match from existing Providers or source additional offers as necessary, and in some implementations with knowledge of the general quantities of existing and/or forecasted supply of offers.

In the system, this terminology can be a little confusing because it is a reverse market: one where the buyer and seller roles are reversed. A Consumer, one who is looking for a service to be performed, is not offering any services. They are presenting an offer to pay a Provider for that service. Therefore, they are presenting what is traditionally defined as an “ask”. For clarity, we use the term “order” for a Consumer's ask offer. A Provider offers on work to be performed, offering to complete service contracts and receive payment. For clarity, we use the term “offer” for a Provider's offer of services. When talking in general terms about orders and/or offers, we use the term “proposal” for concepts which apply to both. When discussing the relative fitness of the match of at least one order against at least one offer, we call these “counter-proposals”.

### 5.1.1 Fungibility of Services

In a consumer services marketplace, the role of a trusted broker can only be assumed by ensuring that offered services meet reasonable criteria for interchange, e.g. they are fungible. This requires standardization of the aspects of fungibility: service specification, quantity, and quality.

In the case of service specification, a common description of services is provided by the service profile.

In the case of quantity, the system normalizes the financial terms used to describe service(s) to be performed. The system normalizes all services to be defined by a cost per unit metric. Materials costs may be internalized (i.e. composed into the rate), externalized (i.e. “cost plus”) wherein the plus does not factor into the offer), or factored (i.e. four party transaction) based on the service definition. In any case, materials costs are not a visible component of the normalized rate. In this way any offer can be measured by the aggregate cost of units of service times the per-unit cost.

On the other hand, the notion of equivalence of quality for a service can be difficult to measure. A commodities exchange relies on the good which is being traded to be pre-defined in terms of quality (e.g. crude oil vs. heating oil). The system relies upon its reputation system to quantify this normally subjective facet of doing business. While this is challenging, uniformity of quality is a considerable problem among the many services in the existing ad-hoc market. The system relies on several of its unique aspects to accomplish this normalization. One such aspect is eliminating the concept of a global reputation such as a Provider star rating. Instead all factors of reputation are given meaning only on a per proposal basis when matched against counter-proposal(s). This effectively creates a proposal-specific reputation metric. Another aspect is using a multi-factor reputation weighting system as a proxy for quality, where the reputation factors are updated automatically through a Provider's use of the system and by the system's automated access to information repositories such as credit scores, licensing bureaus, and social networks.

Additionally, the system allows reputation metrics to be combined with other factors such as price to enable the definition of equivalence to span all available information. In this regard, fungibility is achieved in the eyes of the counterparties. For example, if a Consumer is willing to pay a higher price for a better Provider, but only within a limit of budget, there exist a class of Providers who are good matches and hence substitutable, but others who are not because their prices are too high, even though they meet all criteria defined for measuring reputation, and others because they do not meet the same criteria.

### 5.1.2 Profiles

Several types of profiles are maintained by the system. These include:
Service profiles, by project type and location,
Participant profiles, including
   Consumer profiles, including service locations, service history and reputation,
   Provider profiles, including Provider particulars, service history and reputation information.

More information about each of the different types of profiles is provided below.

### 5.1.3 Sourcing

The marketplace requires active participants making proposals in order to function, e.g. the participants must not only be known to the market, but they also must be conducting activities that the marketplace can manage. Sourcing includes the activities of identification and qualification of participants, and the solicitation of participation where necessary.

Identification and qualification activities include:
Verification, first time and continued, of Provider and Consumer-provided information, including identity, certification and accreditations, licenses, etc.
Identification of required or desirable reputation information,
Identification of additional participants.

The system can automatically identify additional participants and solicit them to engage if there are insufficient participants already using the system. Alternatively, engagement solicitations may be targeted at past Providers who do not have current offers in the system and/or inducing current participants to provide offers for services related to services that they already provide through the system. For example, a plumber who currently has an offer for general plumbing services in the system may be solicited to provide an offer for changing a toilet. The solicitation is symmetric, where Consumers may be similarly solicited to engage with the system based upon identification or lack of current participation. If there are a large number of handyman service offers, but a lack of consumer orders, the system may solicit participants who in the past have used a handyman or similar services, expand to the larger body of Consumers to attract orders for this type of service, or offer discounts or other incentives to drive participation.

### 5.1.4 Reputation

The reputation of participants is established through public and private information sources, including social networks, and in general, by the act of transacting business within the marketplace of the system. Reputation is defined by a combination of:
Identity,
Verifiable information about the participant,
Historical transaction records for transactions conducted within the system, and
Objective feedback provided by other trusted participants.

It should be noted that the system does not make Provider recommendations, performs no reviews, has no pre-selected or preferred Providers, etc. It also gathers no subjective rating information, as its purpose is to match based on objective measures. This differentiates the system from all of the reputation and recommender systems that are based upon participant-generated subjective feedback.

A first challenge in establishing a participant's reputation is having confidence in the online identity of the participant, and in associating aspects of the online identity with physically verifiable facts. Some aspects are straightforward to verify, such as the street address of a business. Others aspects are more complex, and involve attributes of the provider, including licensure, certifications, awards, existing trust relationships, and the objective feedback of others about the participant. One aspect of these more complex aspects of reputation is that there is a verification requirement that is ongoing. For example, licensure is subject to expiration and subsequent renewal, or to forfeiture. The system continually verifies these aspects of the digital identity as part of its ongoing reputation management activities.

A second challenge is the integration of historical transaction records. By cross-referencing reputation sources with actual transactions that generally have physical presence; the system can establish strong identity information bound to contextual reputation data. Every transaction creates one or more connections, which may be leveraged to generate demographically relevant reputation information. Each transaction is associated with implicit and explicit objective feedback, which may be used as part of the historical transaction records evaluation for reputation. In addition, reputation factors can be calculated using information from incomplete or partial transactions in the system, such as counts of transactions that do not complete or are disputed, ratios of completed to not completed, or transactions in which the Consumer and Provider simultaneously withdraw their respective proposals after a match has been made, or in which a resulting contract is cancelled by mutual agreement.

The third challenge is the determination of reputation within a participant's trusted network. A Consumer would necessarily trust a Provider that a friend recommends more than one that has been stumbled upon. Unlike referral networks, the recommendation need not be explicit; the friend really needs only to be satisfied with the services and has expressed that satisfaction to the system.

Social networks are an invaluable source of information about reputation. Both parties naturally use their social networks to find Providers, Consumers, and projects, but there are not automated mechanisms available to integrate this information into a service marketplace. These connections are invaluable tools for driving knowledge into the system to create a more effective marketplace. The system can traverse existing social graphs between a participant and their relationships in order to establish certain aspects of reputation, such as recognizing when a participant has a good reputation in the eyes of friends in a user's network, and more importantly, a friend who is a trusted individual. The same social network can be explicitly queried automatically for input into an upcoming or ongoing request. Trust may also be expressly specified to include specific individuals who are recognized as having a trusted opinion, and conversely exclude others. For example, Fred trusts Joe to have good opinions about plumbers, and believes that John wouldn't recognize a good plumber if he met one. By automating the process of traversing social graphs, maintaining person/trust relationships, and then using social graphs to influence calculated reputation, the system preserves the natural processes while offering improved efficiency. A side effect of using social graphs to identify and validate parties is that the system can expand its participants along these existing networks.

### 5.1.5 Matching

Offers are matched to orders according to the stipulations of the market and its order matching procedures, published by the market to its participants. Services provided through the system are treated as fungible entities. That is, it doesn't matter who does the work, as long as it gets done in the manner requested by the terms of the proposal (scheduling, price, quantity, quality, etc.). For example, a Consumer's order is matched to the most appropriate Provider's offer based on such things as price, location, type of service requested, reputation (weighted in various ways), or other factors, and any Provider meeting the requirements is eligible to be matched.

In practice, there are numerous dimensions along which variations occur, some of which are listed below:
Single-item vs. multi-item or packaged offers
Homogenous vs. heterogonous multi-item
Offer/Order terms
At the market price, limit or not to exceed price, . . .
Offer in force until complete, good for a day, fill or kill, . . .
Withdrawal or modification of terms

Matching of Consumers' orders and Providers' offers is done by the system using a matching function based on computation over a specified combination of service requirements identified in the respective proposals and information in the participant profiles (pricing preferences, desires, location, reputation, capabilities). The matching function further utilizes real-time information about the participants, such as their current calendar availability, current reputation information, and/or their current location if available when specified by the respective proposals.

Reputation as defined by this system is not an absolute measure, but is relative to the available counter-proposals at the time of matching. For example, one Consumer may express a preference for Providers who have completed many projects in the system, while another prefers Providers who are trusted by their network, or a third consumer cares about both aspects but thinks trust is more important than completing projects and as such can weight each aspect. Alternatively, a Consumer may express a preference (or even a requirement) to use a specific Provider. For example, a Consumer may want a Provider that they have previously used and been happy with to provide the service.

### 5.1.6 Contract and Securitization

The exchange of goods or performance of services does not happen instantaneously. The marketplace fulfills its role by creating securities, e.g. legal contracts, to capture the promise of trade rather than the exchange itself. These securities are called “contracts.” These securities become financial instruments with which the marketplace may enable additional trading, such as with a futures or commodities exchange. Possession of the contract security represents the right to receive its benefit, financial or otherwise.

A security represents a promise by one or more Provider(s) to complete one or more service(s) according to a set of specified terms for one or more Consumer(s). If escrow terms are defined, the participants accept completion of the security, and upon accepted completion, the security is redeemed and payment for the service is released from escrow. Note that progress payments may be allowed by the system, but the security itself is not considered redeemed until final payment has been released. In the case where a recurring service is agreed upon, the system may elect to create individual securities for each separate instance of the service, or may create a single security that represents the set of services to be performed.

Once a standard form of fungible service contract is created, many other derivative or enclosing forms can be added. For example, a contract can be re-introduced to the market by a participant in an attempt to resell the business that he has won. As long as the original terms of the contract are upheld, an additional transaction functions as a wrapper around the original contract, adding any additional terms of exchange between the participants.

### 5.1.7 Post-Proposal Acceptance and Contract Creation

Once an proposal from a participant has been submitted to the system, it is verified to ensure that it meets the basic requirements of the system for proposals in its service category. If verified, the proposals are made available for matching against counterparties until they have been matched or the proposal expires. Typically, proposals contain an expiration time (e.g. T-notify, see below) prior to the latest date on which the service is to be performed. This is to allow a buffer for parties to be contacted and prepared for the work. For example, a Consumer who wants their hair cut cannot simply have a contract appear on their schedule 15 minutes before the haircut, as it may not be feasible to travel to the service location in time.

Once a set of proposals have been matched, typically each party is notified and asked to endorse the resulting contract. If either party declines, the underlying proposals are released to the marketplace to continue attempts to match. This continues until either party changes his/her mind about having the service performed and cancels their proposal, until a job is accepted by approving the contract, or a proposal expires. A participant can adjust any unmatched proposal, or cancel the original proposal and submit a new one, if a counterparty cannot be found to accept a proposal as initially specified. For example, the Consumer can increase the maximum budget, or change the required time table if a Provider is not available who will accept the Consumers initial proposal.

### 5.1.8 Post-Service Activities

The system also tracks Consumer and Provider satisfaction histories in order to produce and manage reputation information for the counterparties. After a contract completes, each counterparty is requested to provide explicit objective feedback in order to assess the other counterparty(ies) performance. One challenge of traditional rating systems is that they are subjective. As such, they are relatively easy to manipulate and are subject to assessor bias. To overcome these limitations of traditional rating measures, the system's assessments preferentially take the form of a question answerable using yes/no or other binary answers, such as “I would hire the Provider again/I would not hire the Provider again” Conversely, the Provider is requested to assess customers using similar binary-answerable questions such as “I would/would not work for this Consumer again.” The precise questions may vary; the benefit comes from having objective questions that relate directly to the work at hand for which the answers map to a binary outcome. The system profile and participant profiles may contain lists of appropriate questions categorized on a service-type by service-type basis. Such binary outcomes overcome the subjective nature of “number of stars”, 1-10 satisfaction scale or other rating schemes of recommendation systems.

Additionally, the system creates implicit feedback information from other information stored in, or accessible by, the system. The implicit feedback information is then made available for use by other aspects of the system. The system's correlation of explicitly provided simple binary assessments and implicit feedback information are strongly correlated to participant satisfaction and whether a participant can be recommended to others. The definitions of implicit feedback types, the source information used, and the conversion algorithms for the conversion of raw data to implicit feedback information are stored in the system and participant profiles. Implicit feedback types and calculations may vary on a service-by-service basis, location-by-location basis, or based upon specific aspects of participants, proposals, and services.

For example, implicit feedback may be based upon the payment information recorded in the system, such as whether a tip was provided and how large the tip was as a percentage of the transaction. This payment information is sourced from the historical transaction records of the system, from a payment subsystem managed as part of the system, or managed as part of an externally integrated payment system. The tip amount, in absolute amount, and in relative percentage of the transaction may be measured, and then compared against metrics defined for the specific service (or equivalent service) on a location-by-location basis. This allows for variations in local tipping custom. The definition of where the access the historical transaction records, integration information (if required), and the mapping of transaction fields and values, and any computations and comparison values are defined within one or more aspects of the respective system and/or participant profiles.

As a consequence of using the system, any change orders or disputes over work and/or price are also noted in the historical transaction record, and may be used as part of the calculated reputation.

### 5.1.9 Implementation

The system provides a consumer services trading platform offering a web-based front end as well as mobile client access, current activity and historic pricing market data feeds that are filtered in accordance with market and participant specifications, and numerous integration points for access to external data sources and services

Each of the parts of the system can be implemented using computer-implemented services on standard computer servers, with the participant interface components being implemented as a web-based front end or other thin-client technology, a thick-client application, on typical desktop or laptop computers, as well as with mobile devices such as tablets and smart phones. More implementation details are provided at appropriate points in this disclosure.

These and other aspects and advantages will become apparent when the Description below is read in conjunction with the accompanying Drawings.

### 5.2 Definitions

The following definitions are used throughout, unless specifically indicated otherwise:

| TERM | DEFINITION |
|---|---|
| Entity | A person or company upon whose behalf an agent acts. |
| | Synonymous with user. |
| Fungibility | The property of a good or a commodity whose |
| | individual units are capable of mutual substitution. |
| Offer | A request from a Provider proposing to perform |
| | specified services. |
| Order | A request from a Consumer seeking the delivery of a |
| | service. |
| Proposal | A representation of an offer or an order. |
| Feedback | Information related to the conduct or performance of a |
| | participant or their proposals. |
| Feedback, explicit | A record of the ratings assigned a participant by other |
| | parties to past transactions involving that participant. |
| Feedback, | A rating or set of ratings calculated by the system upon |
| implicit | based upon information associated with one or more |
| | transactions. |
| Reputation | A set of values for a participant that are used during |
| | proposal matching to differentiate participants based |
| | upon explicit and implicit feedback, including licenses, |
| | bonds, time in business, payment history, number of |
| | transactions completed, and rate of completion of |
| | transactions. |
| Sourcing | The activity of bringing a new participant into the |
| | system. |
| Network Sourcing | The activity of a participant bringing a new participant |
| | into the system. |
| Pricing function | A function used as part of the matching process that |
| | combines reputation, required schedule, unit price, and |
| | other factors. The pricing function is defined by the |
| | system and is published to the system participants. |
| Weighting factors | Factors used to adjust values used in the pricing |
| | function, matching process, or other aspects of the |
| | system to cause some value inputs to affect the final |
| | result more than others. |
| Thresholds | “Go/no go” selectors for matching Providers and |
| | Consumer proposals. |

### 5.3 Item Number List

The following item numbers are used throughout, unless specifically indicated otherwise.

| # | Name | DESCRIPTION |
|---|---|---|
| 100 | Services Marketplace | A system supplied by a trusted entity and used by |
| | | Providers and Consumers to interact so as to |
| | | contract for service provision. |
| 110 | Consumer | Simple consumer of the system |
| 120 | Provider | Simple provider of the system |
| 130 | Consumer/Provider | An entity that is acting as both a Consumer and |
| | | Provider in the system |
| 140 | Consumer Group | A group of entities acting as a single or aggregate |
| | | Consumer in the system |
| 150 | Provider Group | A group of entities acting as a single or aggregate |
| | | Provider in the system |
| 160 | Consumer/Provider | A group of entities acting as both Consumers and |
| | group | Providers in the system |
| 1000 | Marketplace Processing | The part of a Service Marketplace that processes |
| | | proposals, supports communication between |
| | | Providers and Consumers, notifies Providers and |
| | | Consumers as needed, manages Contracts and |
| | | Reputation data, and other processing needs of a |
| | | Services Marketplace |
| 1100 | Offer Manager | The part of a Service Marketplace that deals with |
| | | Offers made by Providers. |
| 1110 | Offer Filtering | The part of an Offer Manager that creates subsets |
| | | of available offers that each meet specified |
| | | requirements. |
| 1120 | Offer Normalizer | The part of an Offer Manager that adjusts offer |
| | | terms to a standard form for purposes such as |
| | | comparing offers to orders. |
| 1130 | Offer History | Storage for current and past offers, as well as |
| | | transaction history concerning these offers. |
| 1140 | Provider Data Storage | Storage for information about Providers, such as |
| | | name, address, method of contact, work area, types |
| | | of service offered, etc. |
| 1200 | Marketplace Matching | The part of a Service Marketplace that matches |
| | | orders to offers such that the requirements of each |
| | | are met. Matching may be weighted by various |
| | | factors. |
| 1300 | Contract Manager | The part of a Service Marketplace that manages |
| | | contracts, including recording contract |
| | | agreements, storing past contracts for future |
| | | reference, and tracking payments for completed |
| | | contracts, or contract milestones. |
| 1310 | Contract Store | The part of a Contract Management system that |
| | | stores active contracts. |
| 1320 | Contract History | The part of a Contract Management system that |
| | | stores completed contracts and related data, such |
| | | as payment history. |
| 1330 | Payment Manager | The part of a Contract Management system that |
| | | tracks payments made for active contracts. |
| 1400 | Order Manager | The part of a Service Marketplace that deals with |
| | | Orders made by Consumers. |
| 1410 | Order Normalizer | The part of an Order Manager that adjusts order |
| | | terms to a standard form for purposes such as |
| | | comparing orders to offers. |
| 1420 | Order Storage | The part of an Order Manager that stores open |
| | | orders for reference as needed by aspects of a |
| | | Service Marketplace. |
| 1430 | Order History | Storage for completed orders and related data, |
| | | such as completion date and evaluations. |
| 1440 | Offer History Manager | Interface between Providers and their offers, the |
| | | contracts manager, and maintains historical |
| | | information about offers. |
| 1450 | Service Profile | A part of the system profiles. |
| | | The system profile comprises taxonomy of services |
| | | and ontology of service terms against which |
| | | service proposals may be matched during |
| | | normalization. May include instructions on a |
| | | service and location basis for calculating implicit |
| | | feedback. |
| 1500 | Reputation Manager | The part of a Service Marketplace that deals with |
| | | reputation and relationships among and between |
| | | participants. Reputation data can be used to |
| | | weight, prohibit, or mandate matching of proposals |
| | | between participants, for purposes of adjusting |
| | | payment terms, for recommendations for |
| | | participants, or for other purposes. |
| 1510 | Third Party Interfaces | The part of a Reputation Manager that deals with |
| | | data exchange between a Service Market and a |
| | | third party system, such as a social network |
| | | (Facebook, Google+, LinkedIn, etc.). |
| 1520 | Social Net Manager | The part of a Reputation Manager that tracks |
| | | relationships between and among Providers and |
| | | Consumers. Data tracked may originate within a |
| | | Service marketplace (e.g. past contracts, explicit |
| | | linkages, or sourcing history), or be from external |
| | | sources, such as third party interfaces. |
| 1525 | Social Data Storage | The part of a Social Net Manager that stores social |
| | | network data. |
| 1550 | Sourcing Manager | Manages sourcing activities |
| 1555 | External Sourcing | The part of a Sourcing Manager used to |
| | | automatically increase the number of participants |
| | | in a Service Marketplace. Participants sourced can |
| | | be targeted to specific service types, locations, |
| | | price ranges, specific proposals, or other factors. |
| 1600 | Notification Manager | The part of a Service Marketplace that does |
| | | notification of participants when significant events |
| | | occur, such as orders, offers, acceptances, |
| | | contracts, service completions, and payments. |
| 1700 | Marketplace Feed | Provides a feed of current and/or historical |
| | | marketplace information. |
| 2000 | Provider agent | Component representing a Provider (e.g. a |
| | | Provider agent) that provides offers within a |
| | | Service Marketplace, for which the Provider entity |
| | | is responsible for ensuring that contracted services |
| | | are performed. |
| 2000a | Provider Agent | Instances of Provider agents within a Service |
| 2000b | Components | Marketplace. |
| 2000c | | |
| 2000d | | |
| 2010 | Standard Offer Template | A template used to construct standard offers made |
| | | by one or more Providers. The template can |
| | | comprise offer text, terms of service, price ranges, |
| | | scheduling limitations or requirements, job size |
| | | limitations or requirements, and other criteria |
| | | needed to match an offer with an order. Standard |
| | | Offer Templates can vary by type of work, by |
| | | Provider, by time of year, or by other factors. |
| 2020 | Provider Calendar | Data concerning a Provider's availability and |
| | | current contracted work time. Used to determine |
| | | whether a Provider is available to accept a given |
| | | time-restricted order. |
| 2030 | Provider Constraints, | Data concerning a Provider's capabilities and |
| | Preferences, and | preferences, as well as templates used to construct |
| | Templates | standard and custom offers. |
| 2040 | Provider Taxonomy | A taxonomy of Provider services and service terms, |
| | | for use in constructing offers. |
| 2050 | Provider History | Past offers, contracts, and other historical data |
| | | about the Provider. |
| 3000 | Consumer agent | An agent representative of a Consumer entity that |
| | | provides orders within a Service Marketplace, and |
| | | for which the Consumer entity is responsible for |
| | | paying for contracted services once they are |
| | | performed. |
| 3000a | Consumer Agent | Instances of Consumer agents within a Service |
| 3000b | Components | Marketplace. |
| 3000c | | |
| 3000d | | |
| 3010 | Service request (or | Service Requests are Consumer inputs used in |
| | request in general) | constructing orders. |
| | | Orders are Consumer service requests that have |
| | | been converted by attaching terms, normalizing, |
| | | etc. and making them available for fulfillment in |
| | | the marketplace. |
| 3020 | Consumer Calendar | Data concerning a Consumer's available work |
| | | dates and current contracted work times. Used to |
| | | determine what times a Consumer has available to |
| | | accept a given time-restricted offer. |
| 3030 | Consumer Constraints, | Data concerning a Consumer's constraints and |
| | Preferences, and | preferences, as well as templates used to construct |
| | Templates | standard and custom orders. |
| 3040 | Consumer History | Past orders, contracts, and other historical data |
| | | about the Consumer. |
| 4000 | Responses | Data concerning responses to previously made |
| | | requests. For example, an acceptance of an offer, |
| | | or an offer in response to an order. |
| 4010 | Standard Offer | An offer constructed from a standard offer |
| | | template being entered into a Service Marketplace |
| | | by a Provider. |
| 4020 | Custom Offer | An offer constructed manually by a Provider being |
| | | entered into a Service Marketplace by a Provider. |
| 4030 | Order | An order being entered into a Service Marketplace |
| | | by a Consumer. |
| 4040 | Order Result | A response to a previously entered order that |
| | | specifies whether the order has been matched with |
| | | an offer, and associated data. |
| 4050 | Contract | A proposed contract between a Consumer and a |
| | | matched Provider for an ordered service. |
| 4060 | Optional Ack/Approved | A response by a Consumer to a proposed contract |
| | | that approves the contract proposal. |
| 4070 | Optional Completion | A report by a Consumer that a service has been |
| | Reporting and | completed, and an evaluation of the Provider's |
| | Evaluation | performance of the service. |
| 4080 | Offer Results | A response to a previously entered offer that |
| | | specifies whether the offer has been matched with |
| | | an order, and associated data. |
| 6000 | Offer Structure | An exemplary data description for an Offer |
| 6010 | Parties | The list of parties (Consumers and Providers) |
| | | involved in the Offer. |
| 6020 | Rates | The rates charged by each of the Provider parties |
| | | to the offer. |
| 6030 | Other Offer Data | Implementation-dependent offer data, such as date |
| | | of offer, expiration date of offer, alternate contact |
| | | information, etc. |
| 6040 | Fulfillment Terms | Data specifying contractual requirements for the |
| | | offer, such as access to work area, material supply |
| | | responsibilities, cleanup requirements, work |
| | | quality requirements, etc. |
| 6050 | Service 1 | Specification of the first service to be provided |
| | | under the offer. |
| 6060 | Service 2 | Specification of the second service to be provided |
| | | under the offer. |
| 6070 | Units | Unit of pricing for the associated service provided |
| | | under the offer. |
| 6080 | Price/Unit | Cost per unit for the associated service provided |
| | | under the offer. |
| 6090 | Contract | Contract specification, including job size, |
| | | scheduling requirements, start date, location of |
| | | work, completion date, etc. |
| 6500 | Contract Structure | An exemplary data description for a Contract. |
| 6510 | Contract Parties | The list of parties (Consumers and Providers) |
| | | involved in the Contract. |
| 6520 | Rates | The rates charged by each of the Provider parties |
| | | to the offer. Price/Unit (e.g. $10/hour, |
| | | $100/sidewalk). |
| 6530 | Other Contract Data | Implementation-dependent offer data, such as date |
| | | of contract effectiveness, alternate contact |
| | | information, penalty clauses, etc. |
| 6540 | Fulfillment Terms | Data specifying requirements for fulfillment of the |
| | | contract, such as cleanup requirements, work |
| | | quality requirements, etc. |
| 6550 | Service 1 | Specification of the first service to be provided |
| | | under the contract. |
| 6560 | Service 2 | Specification of the second service to be provided |
| | | under the contract. |
| 6570 | Units | Unit of pricing for the associated service provided |
| | | under the contract. |
| 6580 | Price/Unit | Cost per unit for the associated service provided |
| | | under the contract. |
| 6590 | Contract Terms | Terms of the contract, such as job size, |
| | | calendar/scheduling, and location of work. |

### 5.4 Exemplary System Architecture

### 5.4.1 High Level Diagram of a Services Marketplace

FIG. 1 is a diagram showing a high level representation of an exemplary implementation of a service marketplace system (100) comprising at least one marketplace processing component (100) along with a plurality of participants (110, 120, 130, 140, 150, 160) acting in various roles as supported by their respective participant agents (e.g. 2000a, 2000b, . . . , 3000a, 3000b, . . . ).

In this system, service requests are submitted to the marketplace system, normalized, converted to marketplace orders, verified, and then managed on the participants' behalf. The methods of creation, normalization, verification, and management of proposals are innovative aspects of the system.

The service marketplace system acts as an broker for transactions to fulfill participants' proposals by providing a market that includes automated sourcing of suitable Providers using various crowd-source, social network, and project-based techniques One aspect is the recognition that most consumer services are, by nature, fungible, though this is contrary to widely held belief. For example, a consumer believes that their particular landscape is very different from their neighbors, while the landscaper calculates those differences such as square feet of lawn and size of tree beds and converts them to an estimate of man hours in order to schedule his team. By automating this process, proposals for these services can be a priori normalized and traded in automated market-style approaches. Innovative methods of matching Providers to Consumers and aggregating Providers, including the use of social networks to help define participant reputation or to meet Consumer requests, are supported by this system.

Once a plurality of proposals are matched and contracts created, indicating that the participants have reached an agreement on the key aspects of the services to be provided, the system supports the participants with managing the resulting contract to completion, such as providing necessary workflow if change orders are required.

As the work is completed, the system handles collection of payment, takes a percentage as a brokerage fee, and passes the remainder to the service Provider. The system also can escrow payment for the work as called for by contracted terms of service defined in the requests.

The system further solicits and collects explicit objective participant satisfaction information, and collects implicit participant satisfaction information from participants, proposal, and contract histories, and makes this information available to the matching component and as part of reputation.

The system further provides an integrated infrastructure to make the above aspects seamless and easy to use from both the Consumer and Provider standpoint. The system provides a communication infrastructure that enables Consumers and service Providers to interact effectively, to set up schedules and calendars for participants, to record contracts, and to supply payment escrow services, as well as providing a platform for providing other business services where desired by the service Providers. These additional services may include services such as payment processing, record-keeping, cash flow analysis, maintaining reference accounts, insurance, subcontracting, and payroll.

Returning to FIG. 1, participants of the system can be individual people, companies, or other entities (110, 120, and 130), or groups of these acting together (140, 150 and 160). Individuals, companies, or groups of individuals and/or companies (collectively, entity) can be acting as Consumers (110 and 140), as Providers (120 and 150), or both (130 and 160). Each entity that is acting as a Consumer is represented within the Marketplace System (100) by a Consumer agent component (3000a, 3000b, 3000c, and 3000d). Each entity that is acting as a Provider is represented within the Marketplace System (100) by a Provider agent component (2000a, 2000b, 2000c, and 2000d). The Consumer and Provider agent components provide the end-participant interfaces, data storage, localization integration, and other participation needs of participants that are using the system to obtain and/or provide services and interact with the Marketplace Processing component (1000) as described herein.

In particular, participant 110 acts in the Consumer role and is represented in the system architecture by Consumer agent component 3000a. Consumers provide orders for services to the market and receive contracts for services to be provided to them as a result of the market operation. Additional details related to the Consumer agent component and its interactions with Marketplace Processing component(s) (1000) are described below.

Participant 120 acts as the service Provider role and is represented in the system architecture by Provider agent component 2000a. Service Providers provide offers to provide services to the market and receive contracts to provide these services as a result of the market operation. Additional details related to the Provider agent component and its interactions with Marketplace Processing component(s) (1000) are described below.

Participant 130 acts in both the service Provider role and in the Consumer role, and is represented in the system by Consumer agent component 3000b and Provider agent component 2000b. In some instances, the participant acts first as a Provider and then as Consumer. In other instances, a participant may be acting in both roles simultaneously. Proposals provided to the system may be unrelated (e.g. a person ordering lawn mowing and offering plumbing services) or related (a person offering general construction contracting services and ordering plumbing services to fulfill part of the general construction contract.)

The system also lets individuals and small Providers take on more complex tasks by forming multi-party contracts (contracting as an aggregate entity). When forming aggregate entities, further sourcing can be used to locate additional Providers when existing Providers in the system are not available or appropriate. When matching proposals, an aggregate entity is treated as the individuals that make it up.

Participant 140 is a group of participants acting as a single aggregate Consumer (such as a buying club or homeowners group) to purchase services for each Consumer in a single lot. The group of participants is represented in the system by Consumer agent component 3000c. Participant 140/3000c differs from a traditional Consumer in that the Consumer component manages a set of proposals as a single, multi-part proposal for services.

Participant 150 is a group of Providers acting together as a single aggregate Provider (such as a joint venture of a plumber, electrician, and carpenter who decide to work together). They are represented in the system by a single Provider agent component 2000c. Participant 150/2000c differs from traditional Providers who subsequently subcontract out work (e.g. participant 130 in the general contractor example above) in that contracts awarded to the group are automatically allocated to specific entities for fulfillment.

Participant 160 represents a mixed group acting as a single aggregate Consumer and Provider.

### 5.4.1.1 Proposal Timeline Diagram

Similarly, it is useful to understand the timing of a proposal in the system. FIG. 2 illustrates the request timeline for requests managed by the system. Table 1 lists the significant timeline milestones.

TABLE 1

| Timeline State | Description |
|---|---|
| Draft (7210) | T_{draft}—Time at which a request is stored in the agent. |
| Submitted (7220) | Tₛ - Time at which an order or offer is entered into the system. |
| Committable (7240) | T_{c}—Time at which a party is willing to be committed to a proposed |
| | transaction. Prior to this time, the system enforces no penalties for |
| | cancellation. |
| Committed (7258) | T_{d}—Time at which the system may initiate the creation of a contract |
| | between counterparties. Effectively any time after the later of the two |
| | parties T_{c}(7240). |
| Expire (7290) | Tₑ—Time at which an order or offer is terminated by the system if it has |
| | not been committed to a potential counterparty. |
| Reserve (7255) | Tᵣ—Time at which the system identifies parties to a potential transaction, |
| | only when prior to the T_{c}(7240) of both parties. Neither party is |
| | committed and the market system is able to continue to search for better |
| | quality transactions. |
| Contact Exchange (7260) | T_{ce}—Time at which the system notifies parties of their counterparty |
| | identities and any additional details of the transaction which are required. |
| Notify By (7250) | Tₙ—Time at which a party has expressed that they must receive full |
| | details concerning the transaction. Must be greater than or equal to |
| | Contact Exchange (7260). |
| Resourceable (7265) | Tᵣₑ—Time at which a transaction is removed from a secondary market if it |
| | has not been committed to a substitutable party. |
| Cancellable (7270) | Tₚₒₗ—Time after which the cancellation policy of the transaction (in lieu |
| | of the system behavior) is enforced. Must be greater than or equal to |
| | Contact Exchange (7260). |

Each proposal may be described as having a number of time-based conditions during its lifetime. Specific times during this timeline are important, as they represent changes in the actions permitted on a state (e.g. state diagram above). The interaction between time-based condition and request state may induce mandatory state changes or market actions.

A proposal is entered by a participant into their agent component at time T-draft (7210). The proposal is visible only to the participant. The proposal stored in the agent may incomplete.

A proposal is submitted to the system by the agent component as shown on the timeline as time T-submitted (7220). The submission occurs under the control of the participant or is performed automatically by the agent component. Automatic submission is useful for creating proposals that are automatically renewed when they expire or are matched (e.g. a standing proposal), or for automatically changing terms or instructions of proposals when they have not been matched within a specific period of time. The proposal is validated at time of submission, and upon completion of validation, the proposal state is changed to open at time T-open (7230). The start time of time-based proposals (duration of an open proposal) are based upon T-submitted (7220).

At any time after T-open (7230) and before T-expire (7290), the proposal is eligible for matching against other proposals by the market. However, the participant is not required to accept a match if they have reserved time. For example, a conditional order could exist which expires at a specific time. Rather than submitting a new proposal at that time, an agent could submit a proposal, but not allow the market to commit the participant until after this expiration time, thus allowing the agent to remove the second proposal if the first successfully negotiates. This time is called T-committable (7240), a time after which a participant is willing to accept a match. T-committable (7240) can be greater than or equal to T-open (7230) and less than or equal to T-notifyby (7250). By supporting differing T-open (7230), T-committable (7240), and T-notifyby (7250) times, the marketplace enables conditional matching of proposals. These conditional matches are unconditionally cancellable in the interval between T-open (7230) and T-committable (7240), and are committed as a contract not later than T-notifyby (7250).

A proposal expires at T-expire (7290), at which time it is removed from matching consideration and the user's agent is notified that the proposal was not matched. T-expire (7290) must be greater than T-committable (7240) for a proposal to pass validation.

Note that the system is not required to match proposals immediately, but has a window of time during which to match the proposals. Matching may occur at any time within the open window. The matching algorithms do not require that matches are immediately made when presented, as described below in the section matching.

The time when a match occurs is T-reserve (7255). T-reserve (7255) is when resources for the match are reserved pending confirmation. The system is able to reserve a match any time after T-open (7230). However, it cannot attempt to complete a contract until after both parties T-committable (7240). Thus, T-open (7230) and T-committable (7240) define an early reservation window. T-committed (7258) occurs when the matches have been confirmed by the respective agents and a contract is created and digitally signed by the system. The users/user agents must confirm the matches before time T-notifyby (7250). Once the matches are confirmed, the contract may be managed upon the secondary market until T-contactexchange (7260), when the parties are notified of the contracts terms and counterparties.

Matching operations operate upon proposals between T-open (7230) and T-committed (7258), and the marketplace overall manages proposals from T-submitted (7220) to T-expire (7290) or T-completed (7295). Secondary market operations occur between T-committed (7258) and T-contactexchange (7260).

### 5.4.1.2 Proposal State Diagram

Before the system processes are described, it is useful to describe an exemplary state diagram for proposals as they move through the system. FIG. 3 illustrates states of a proposal as it moves through the system.

A proposal starts in an initial state of Draft (7010), when a participant creates a draft offer or order and stores it within their agent. Draft proposals may not be complete, or may lack other aspects of a completed proposal required to make the proposal processable by the matching component. The participant then submits the proposal to the system (7110), which sets its state to Submitted (7020). If the participant changes his/her mind about a submitted proposal, the participant can cancel the proposal using their agent (7170), and the proposal state is set to Canceled (7070).

If the proposal is not cancelled at this point, the submitted proposal is validated by the market.

If the market system finds the proposal invalid (7125), the proposal is rejected, the user agent notified, and the proposal state is changed to Invalid (7060). The participant can then return the proposal state to Draft (7150), modify the proposal and resubmit it, or cancel the proposal (7160). If the validator finds the proposal to be valid (7120), the proposal state is set to Open (7030) and the proposal made available to the marketplace matching component upon request. If the participant chooses to cancel a proposal prior to fulfillment (7180), the proposal state is set to Canceled (7070).

If the validated proposal is not canceled from the Open state (7030), it remains in the Open state (7030) until the market determines that time has expired (7135) (i.e. time exceeds T-notifyby (7250)) and the proposal is excluded from marketplace matching. At that time, the proposal state is set to Expired (7080). If the marketplace determines a match and notifies the parties (7130), the proposal state is set to Committed (7040). The participant can choose to cancel the proposal at this point (7190), but may incur a penalty for doing so depending upon the values set in the proposal terms. If the proposal is canceled, the state is changed to Canceled (7070). Alternatively, the marketplace can determine a match (7132) and set the proposal state to Reserved (7035). Participants may cancel proposals in the Reserved state (7134), or the marketplace may replace proposals with other proposals that match (7132). If the participant does not cancel the proposal (7134), but instead chooses to confirm the contract (7140), the states of the matching proposals are set to Signed (7050).

Cancellation of a signed contract (7195) may or may not be permitted, depending on the proposal terms, and may or may not incur a penalty.

### 5.4.1.3 Contract States

Once a set of proposals are combined into a contract and the contract “signed”, a single contract exists binding the plurality of proposals together. This contract moves through the system according to the states described below.

Once a contract is signed, work typically commences and the system begins to track the work process. If no acknowledgement that work has begun is created, the system monitors the contract until the scheduled time has run out, at which time the contract becomes unfulfilled. If the service Provider determines that the contract represents work substantially different than what is determined at the site location, they can either initiate work and file change orders as part of the work process, or mark the contract as misestimated. A misestimated contract allows the service Provider to avoid any reputation impact for not performing work. A Consumer, on the other hand, will face this consequence. An alternate dispute process is provided which allows a Consumer to prevent a service Provider from marking a contract misestimated when in fact they did not show up to perform the work.

Once work has begun, the work process allows for change orders to be created which add, delete or otherwise alter the quantity of work to be performed. If work is not completed in a satisfactory manner or change orders are not accepted by the Consumer, the contract becomes disputed. Through the dispute resolution process, the contract is either resumed to the work process state or terminated.

After work has been completed to both parties' satisfaction, the contract is accepted and final payment is required. Note that during the work process, a service Provider is able to invoice against outstanding sums and change orders as defined in the contract terms. Once accepted, the Consumer must pay within the period defined in the contract, or it becomes defaulted. In the defaulted state, a resolution process may be initiated to attempt to recover payment on behalf of the service Provider. However, the contract state remains defaulted for use as input to the reputation mechanism. A Consumer who defaults on accepted work faces some amount of negative impact to their reputation.

### 5.4.1.4 Proposals (Offer and Orders)

It is now useful to more fully describe proposals. FIG. 4 is a diagram showing the structure of a proposal (6000). The specific data comprising a proposal (6000) can vary from one implementation to another. Those with skill in the art will understand the nature of any additional information needed for particular implementations.

Each proposal (6000) includes references to the participants involved (6010) and their participant agents, such as the exemplar Provider agent (2000) or Consumer agent (3000). This information is used by the system to identify the appropriate participant's agent to route notifications to, and as part of reputation and market filtering/matching activities.

The proposal further comprises information regarding the project price (6020) to be charged. This value is the total cost of the project, and is used by the matching and filtering functions. The nominal price of the proposal is interpreted differently depending upon whether the proposal is an offer or an order. For an order, the price is the maximum amount of money the Consumer has budgeted for the project defined in terms of the pricing schedule. For a Provider, it is the minimum project price that they are willing to accept. In addition to the base price, a proposal may have further terms specifying such items as the minimum or maximum compensation rate, minimum job duration or may specify bounds based on the current or historical market rates.

The proposal also comprises instructions (6030), terms (6040), and inputs (6045) which define aspects of the proposal to the marketplace matching component. These include matching instructions for the market such as optimization preferences, proposal durations and similar aspects. Terms are the elements of a proposal which specify the criteria by which counter proposals will be evaluated such as requiring a provider to have been in business longer than a year. Inputs are the elements of a proposal which are used to supply data to a counter proposal or terms or instructions. In many cases they are proposal specific such as a business location, but are often references to data drawn from a participant's profile such as the provider's total time in business, proposal duration, and similar aspects.

Each proposal (6000) also comprises a list of services to be performed and information about those services, for example, such as Service 1 (6100) and Service 2 (6200) as shown in FIG. 4, each of which has its own pricing units (6110 and 6210), price per unit (6120 and 6220), fulfillment terms such as promised start and completion dates, and other specifications the scope of the work to be performed, the quality of work to be provided, etc. as well as other per-proposal data (6130 and 6230). In some implementations, service data can also be used for materials to be supplied, such as concrete form lumber, cleaning supplies, fuel, etc. Each service specification also specifies additional contractual requirements for the service (6130 and 6230), such as scheduling, location, quality of service, etc.

### 5.4.1.4.1 Instructions

### 5.4.1.4.1.1 Proposal Duration

Proposals define their duration, e.g. the length of time that they are available in the market and are valid to match. These durations define T-notifyby (7250) as described in the timeline in FIG. 2. Table 2 lists an example set of proposal durations supported by the system.

TABLE 2

| Duration | Offer | Order |
|---|---|---|
| Good for day | Offer immediately terminates if | Order immediately terminates if unfilled at |
| | unfilled at the end of the day, defined | the end of the day, defined by midnight of |
| | by midnight of the time zone within | the time zone within which the order was |
| | which the offer was placed. | placed. |
| Good for other | A duration set by the Provider, during | A duration set by the Consumer, during |
| | which the offer is valid. | which the order is valid. |
| Good till | An open-ended offer with no end time | An open-ended order with no end time |
| canceled (GTC) | specified. An artificial end-time may | specified. An artificial end-time may be |
| | be placed by the agent for all GTC | placed by the agent for all GTC offers. |
| | offers. Offers for project services such | |
| | as lawn care may use this term to | |
| | allow the offer to remain outstanding. | |
| Fill Or Kill | A requirement that an offer either be | A requirement that an order either be filled |
| | filled immediately or canceled at the | immediately or canceled. For example, a |
| | specified terms. | Consumer waiting for a cab may wish to find |
| | | service quickly or resort to standing on the |
| | | corner. |

### 5.4.1.4.1.2 Proposal Notification

Notification instructions define the parameters of when an entity must be notified of the details of fulfilled proposal. These instructions include:
Notification date/time—the date/time (local) that the entity must be notified by with the details of a completed contract. This corresponds to T-notifyby in the timeline diagram (FIG. 3).
Notification type—the manner in which an entity wants to be notified for this proposal (may be defaulted from the participant's profile or from the system profile)

It is also possible to provide a separate instruction which differentiates contact exchange and notifyby, such that T-notifyby determines when a participant must be notified of a match and able to sign a contract, with an additional time limit on when contact exchange must occur by. A Consumer who needs to hire bartending services for a party several weeks away may instruct the system to provide early notification that a suitable provider has been contracted, but the details of the provider are not important until closer to the party date when the Consumer is prepared to exchange further instructions such as where to setup within their home.

### 5.4.1.4.1.3 Proposal Commitment and Cancellation

Table 3 lists exemplary commitment and cancellation instructions associated with proposals in the system. Commitment instructions correspond to T-committable in the timeline diagram (FIG. 3). By default, all proposals are cancellable before they are matched except if it contains a Fill or Kill instruction.

TABLE 3

| Term | Offer | Order |
|---|---|---|
| Committable At | An offer can be committed by the | An order can be committed by the market |
| Open | market at any time after it is open | at any time after it is open for matching. |
| | for matching. | |
| Delay Commit Until | An offer cannot be committed until a | An order cannot be committed until a |
| | period has elapsed from the time it | period has elapsed from the time it is open |
| | is open for matching. | for matching. |
| No Cancellation | An offer can be cancelled after its | An order can be cancelled after its contract |
| Penalties | contract has been signed without | has been signed without penalty. |
| | penalty. | |
| Cancel Before | An offer can be cancelled prior to | An order can be cancelled prior to contact |
| Contact Exchange | contact exchange without penalty | exchange without penalty. |
| Cancel Before | An offer can be cancelled prior to | An order can be cancelled prior to the date |
| Service | the date and time of service, or a | and time of service, or a defined time |
| | defined time period prior to service, | period prior to service, without penalty |
| | without penalty | |

### 5.4.1.4.1.4 Scheduling

Proposals define instructions for how the agents and the market should interpret their calendar and additional constraints on scheduling parties. Table 4 lists the proposal scheduling instructions supported by the system. Note that the category ontology and participant profile can define how the system will consume available time. A match for a baby sitter may prevent further matches against baby sitters but allow lawn mowing services to occur at the same time.

Note that for each proposal calendar entries define service windows which bound the start and completion times for any service. They may also define recurrence intervals for services such as weekly lawn mowing. Many services, though, do not use the calendar in this manner, such as immediate taxi service where start time is implied but completion depends on the destination. A future reservation for a taxi may choose to calculate a service window based on the route chosen or estimated.

TABLE 4

| Scheduling | Offer | Order |
|---|---|---|
| Schedule To | A match should consume time on the | A match should consume time on the |
| Calendar | respective calendar. A reserved | respective calendar. A reserved match will |
| | match will mark the time not available. | mark the time not available. A match will |
| | A match will create a schedule event. | create a schedule event. |
| Schedule Is | The market can interpret lack of | The market can interpret lack of |
| Availability | appointments or events as available | appointments or events as available time for |
| | time for scheduling the service. | scheduling the service. |
| Proposal Is | The offer directly specifies its own | The order directly specifies its own available |
| Availability | available fulfillment intervals. | intervals for receiving the service. |
| Schedule Is Non- | The market can consult separate | The market can consult separate free/busy |
| availability | free/busy time defined in the calendar | time defined in the calendar for augmenting |
| | for augmenting non-availability. | non-availability. |
| Job Must Be | The offer should only be matched to | The order can only accept offers which fit in |
| Contiguous | orders which have enough contiguous | contiguous free time on the calendar. |
| | free time to deliver the service in one | |
| | appointment. | |

### 5.4.1.4.1.5 Multi-Item or Aggregate Proposals

Table 5 lists the instructions to the market for handling proposals with multiple service components or aggregate participants. In all cases, the market gives preference to fulfilling the entire portion of a multi-item proposal with a viable multi-item counter-proposal versus splitting its match across multiple participants. The market gives further preference to filling a multi-item proposal quickly once one or more items have been reserved to prevent reservation without completion of a contract.

TABLE 5

| Type | Offer | Order |
|---|---|---|
| All Or None | Require that an offer must be accepted | Stipulate that the order be completely filled |
| | in its entirety. | by its termination deadline, or otherwise |
| | | cancelled. |
| Partial Fill | Allow an aggregate or multi-item offer | Allow a multi-item order to be partially |
| | to be partially committed. The market | committed. |
| | can continue to match the remainder | |
| | before the offer expires. | |
| (Dis)Allow | An offer may allow (or disallow) multiple | An order may allow (or disallow) multiple |
| Aggregates | participants to be considered in | participants to be considered in matching. |
| | matching. | |

### 5.4.1.4.2 Terms and Inputs

These parameters define the base criteria by which a proposal is matched against another, including the required profile or other data to measure by. Boolean quantities may be used as filter attributes applied during a filtering step in order to eliminate proposals from consideration. Other numeric quantities may be used during matching with accompanying optimization instructions.

### 5.4.1.4.2.1 General Thresholds

Many terms and inputs are commonly used across all categories of services in the service ontology. They are listed in Table 6.

TABLE 6

| Term | Input | Definition |
|---|---|---|
| Born Before/After | Birth date | Require a proposal be from a participant of at |
| | | least or at most a specific age. |
| (Dis)Allow Anonymity | Anonymous | Require proposals to be from counter-parties |
| | | who are willing to share contact information. |
| Is Licensed | Licensing (including date of | Individual criteria to ensure that a Provider is |
| | license and last | licensed. |
| | verification) | |
| Is Bonded | Bonding | Individual criteria to ensure that a Provider is |
| | | bonded |
| Is Certified | Certification (including date | Individual criteria of required certifications, e.g. |
| | of certification and last | PDCA (member of Painting and Decorating |
| | verification) | Contractors of America). These may be service |
| | | category specific. |
| Has Insurance | Insurance | Ensure participant carries appropriate insurance |
| | | such as worker's compensation or a |
| | | homeowner's policy for a Consumer. |
| Escrow | Escrow Agent | Require that the counter-party accept escrow |
| | | terms. |
| Preauthorized | Payment Authorizations | Require that a Consumer have pre-authorized a |
| | | payment source for the amount of or some |
| | | portion of the projected service cost. |
| Not Sex Offender | Sex Offender | The counter-party cannot be listed on a public |
| | | Sex Offender registry. |
| Has Criminal Record | Criminal Record | The counter-party cannot have prior criminal |
| | | offenses. (Can be limited to felony, |
| | | misdemeanor, etc . . . ) |
| Current Lien | Liens | The counter-party cannot have an outstanding |
| | | lien against their business or location. |
| Existing Lien | Liens | The counter-party cannot have prior or existing |
| | | liens. |
| Was Bankrupt Recently | Bankruptcy | Within a defined time frame, the counter-party |
| | | cannot have declared bankruptcy. |
| Minimum Time in | Business start date | Require a Provider to have been in business at |
| Business | | least a certain amount of time. |
| Minimum Credit Score | FICO Score | Require a counter-party to have a minimum |
| | | credit score. |

### 5.4.1.4.2.2 Reputation

Table 7 lists example terms and inputs which relate to reputation and trust information gathered by and stored within the system.

TABLE 7

| Term | Input | Definition |
|---|---|---|
| Recommended By Me | Is Recommended | Require that a counter-party be specifically |
| | | recommended by the first party. |
| Recommended By My | Trust Network | Require that a counter-party be specifically |
| Network | | recommended by the first party's network. |
| Excluded By Me | Is Blocked | Prevent match against a counter-party which is |
| | | specifically blocked by the first party. |
| Excluded By My Network | Trust Network | Prevent match against a counter-party which is |
| | | specifically blocked by the first party's network. |
| My References | Trust Network | Only select proposals which the counter-party |
| | | has a minimum number of positive references in |
| | | the first party's social network. |
| Minimum References | Trust Network | Only select proposals which the counter-party |
| | | has a minimum number of positive references. |
| In-sourced Only | Trust Network | Only allow proposals from counter-parties |
| | | which are in the first party's network either by |
| | | prior service engagement or recommendation |
| | | by trusted contacts. |
| Out-sourced Only | Counter-Party(s) | Restrict proposals to counter-parties from an |
| | | enumerated list |

### 5.4.1.4.2.3 Pricing

Table 8 lists example terms and inputs which relate pricing and service budget information.

TABLE 8

| Term | Input | Definition |
|---|---|---|
| Minimum Budget | Budget | Provider's request to match only against |
| | | projects which represent a minimum total cost. |
| Maximum Budget | Budget (Rate * Estimate) | Consumer's request to match only against |
| | | Provider's whose rate or cost estimate does not |
| | | exceed a fixed budget. |
| Minimum Rate | Rate | Providers' request to limit order matching to |
| | | remain above a fixed rate. |
| Maximum Rate | Rate | Consumer's request to limit order matching to |
| | | remain below a fixed rate. |
| Market Rate | Rate | Any request to match only within the market's |
| | | current estimated rate for the service. |
| Minimum Job Duration | Estimate | Provider's request to match only against |
| | | projects which represent a minimum scope of |
| | | work. |

### 5.4.1.4.2.4 Category Specific

Many terms and inputs can be specific to a certain category or service. For example, a babysitting service may define inputs about the number of children, children's ages, special needs requirements, potty training, or if the children are sick. At the same time, terms can be defined which specify the maximum number of children a provider is willing to sit or the youngest or oldest child age. Other terms and inputs can be used to require a provider not be a smoker, be willing to cook meals, help with homework, or supervise swimming.

### 5.4.1.4.2.5 Grouped or Compound Terms

Many terms and inputs can be grouped together to form more complex expressions of constraints or assertions. In the household cleaning service, one could require that a provider be willing to mop and vacuum, while a provider could specify that they are able to mop, dust, vacuum, and do laundry. A consumer wishing to get their driveway shoveled could specify that a provider is allowed to use a snow blower or a shovel, but not a plow. In this way, the use of conjunction, disjunction, and grouping allow for quick expression expansion.

### 5.4.1.4.2.6 Miscellaneous

Table 9 lists other example service terms and inputs.

TABLE 9

| Term | Input | Definition |
|---|---|---|
| Within Travel Distance | Location | Ensure that counter-party or defined service |
| | | location is within a maximum distance. |
| Equipment Provided | Will Provide Equipment | Require that a counter-party provide the |
| | | necessary equipment for the service. |
| Materials Included | Will Pay For Materials | Specify how materials are to be paid for. |
| Require Language | Languages Spoken | Require a counter-party to speak one or more |
| | | languages. |
| Allow Pets | Pets | Require that a provider be willing to work with |
| | | or near pets. |

### 5.4.1.4.3 Prioritization and Optimization Instructions

These parameters define prioritization and market optimization instructions with respect to a proposal.

### 5.4.1.4.3.1 Weight

Table 10 lists a range or set of possible values expressing the relative importance of a particular measure of fitness to match the order.

TABLE 10

| Term | Offer | Order |
|---|---|---|
| Price | Prefer orders with the highest unit | Prefer offers with the lowest unit |
| | rate or total budget | rate or total budget |
| Locality | Prefer orders from local Consumers | Prefer offers from local Providers |
| | nearest the Provider | nearest the Consumer or job site |
| Schedule | An instruction to prefer the order | An instruction to prefer the offer |
| | which is schedule to start earliest | which is schedule to start earliest |
| | within the specified time window, | within the provided time window, |
| | such as for taxi cab or roadside | such as for taxi cab or roadside |
| | assistance offers - whichever order | assistance offers - whoever can get |
| | is the closest to the Provider | to the Consumer quickest |
| Reputation | Orders may have a large number of | Offers may have a large number of |
| | reputation factors. They are not | reputation factors. They are not |
| | exhaustively listed here. It is | exhaustively listed here. It is |
| | possible to either allow a Consumer | possible to either allow a Consumer |
| | to define his form of reputation and | to define his form of reputation and |
| | a weighting against the overall | a weighting against the overall score |
| | score derived from it. Or, we can | derived from it. Or, we can allow |
| | allow each reputation factor to | each reputation factor to weigh |
| | weigh separately. | separately. |
| | Prefer orders with the most | Prefer offers with the most |
| | positive references | positive references |
| | Best reputation in my | Best reputation in my social |
| | social network (positive vs. | network |
| | negative accounting for | Number of projects |
| | distance from the | completed with the |
| | originating party) | Consumer or his trust |
| | Number of Projects that | network |
| | have been completed with | Reputation from external |
| | the Provider or his network | sources such as BBB, Angie's |
| | External sources such as | List, Bing, etc . . . |
| | credit score | Licensing status |
| | Location of house, | Business age, number of |
| | reputation of neighborhood | employees, other corporate |
| | Licensing status | information |
| | Consumer age | Credit rating, D&B score |

### 5.4.2 Detailed Diagram of Services Marketplace

FIG. 5 is a more detailed diagram of an exemplary Services Marketplace (100) focusing on the marketplace processing components (1000). Exemplary implementations described herein are not limiting on other possible arrangements of components, division of functionalities, or interactions between components. In real terms, the system fulfills multiple roles in the actual market, operating as both as the market and as the Provider and Consumer agents. There is no limitation that agents may be provided by third parties to interact with the marketplace processing components.

A Services Marketplace comprises at least one Marketplace Processing component (1000), one or more Provider agent components (2000), and one or more Consumer agent components (3000). For clarity, one instance each of the Marketplace Processing Component, Consumer Agent Components, and Provider Agent Components are shown in FIG. 5, although a plurality of each component may be in use at any particular point in time. Consumers wanting to arrange for the acquisition of services use their Consumer agent component to submit orders (4030) to the Service Marketplace. These orders are matched with offers of service (e.g. 4010 and 4020) from Providers that are using the system to offer services (collectively, “Providers”).

The Provider agent component (2000) of the Services Marketplace (100) comprises the end-participant interface, data storage, and other components that fulfill the participation needs of service Providers. The Provider agent component is described in more detail below.

The Consumer agent component (3000) of the Service Marketplace comprises the end-participant interface, data storage, and other components that fulfill the participation needs of Consumers. The Consumer agent component is described in more detail below.

The Services Marketplace can be implemented on a single server computer system of common construction, or on a plurality of server systems, in which the plurality of server systems are configured to operate cooperatively, in a clustered organization, or redundantly. Some example implementations comprise a single application, an application distributed across a plurality of computer systems, and a collection of cooperating applications representing one or more components or parts of components, present either on a single computer system or distributed across a plurality of computer systems. Each of the server system implementations may be physical or virtual. The Services Marketplace is presented herein as a single system for clarity. Other implementations are possible, based upon implementation considerations understood by those skilled in the art. The messaging and call interfaces for distributed systems are well understood in the art and are not described herein.

The Services Marketplace, Consumer, and Provider participant interfaces can be implemented as a client-server, n-tier application, and/or web application with a web-browser providing access to a web-based front end, other generic or proprietary thin-client technology, or a thick-client application. The participant interface and other services can be provided using typical desktop or laptop computers, as well as on mobile devices such as tablets, smart phones, or PDAs. Some of these devices may have location-aware components, such as a GPS, that may be used to provide one or more location-based aspects of the system. Portions of the participant interface, such as notifications, payments, and acceptance/rejection of offers, can also be implemented using various standard or well understood participant interface methods, such as a web interface, e-mail, SMS text messaging, Instant Messaging (“IM”), automated interactive voice response system phone calls, or mechanisms as would be understood by those skilled in the art.

Integration with location systems can be done for purposes such as selecting the mode of communication to use, for automatically defining the location where a service is to be performed and/or the current location of a Provider or Consumer, or for defining the type of currency to be used for payment. Location systems comprise hardware locations systems, such as those included in mobile devices (e.g. cell phone GPS or tower-triangulation system) as well as network-based geospatial databases such as those provided by, for example, Google Maps.

Integration with existing calendar systems can be implemented using methods such as iCal, CalDav, or Google APIs. Integration with other desktop or mobile applications is also possible, such as adding contact information to address books, auto-dialing phone apps for Provider/Consumer interactions, or opening documents in document readers. Combinations of these technologies are particularly advantageous.

Services Marketplace implementations can incorporate standard support software, such as database management systems (DBMSs), communication libraries, etc., and be implemented in various computer programming languages as will be well understood by those with skill in the art.

### 5.4.3 Marketplace Processing Component (1000)

We first describe the Marketplace Processing component (1000) with only general reference to the functions of Provider agent (2000) and Consumer agent (3000) components. Marketplace Processing (1000) comprises a number of other components, each of which perform one aspect of the Marketplace Processing (1000) functionality. These additional components comprise one or more Offer Manager(s) (1100), one or more Order Manager(s) (1400), one or more Marketplace Manager(s) (1200), one or more Contract Manager(s) (1300), one or more Reputation Manager(s) (1500), one or more Sourcing Managers (1550), one or more Notification Manager(s) (1600), and Marketplace Feed (1700) components, and the necessary messaging and interface components required to integrate the above named components. Together, these components comprise a Service Marketplace (100) that:
Receives and/or solicits proposals,
Determines the “best fit” match between these proposals,
Produces one or more contracts for the provision of services that meet the proposal terms on behalf of participants, and
Manages aspects of these contracts to completion on behalf of participants.
Provides ongoing feedback and historical reporting to participants

Each of these components of the Service Marketplace (100) is now to be described in additional detail.

### 5.4.3.1 Offer Manager (1100)

The Offer Manager (1100) component is responsible for receiving; initial processing, and storage of Provider “Offers” and offer-related materials (e.g. 4010 and 4020). It provides a receiving interface operable to receive offers from Provider agents, specifically the steps of receiving, storage, and processing of Offers and offer-related materials (4010 and 4020) supplied by Provider Agent Components (2000) and/or other components of the system. Generally, these steps include the safe-storage of offers received at the interface in an Offer History (1130) component, normalization and verification steps to normalize offer terms and verify particular aspects of the offer and/or subscriber information using the Normalizer component (1120), and the subsequent provision of filtered offers to the Marketplace Matching component (1200) in response to requests from participants. After offers and offer materials are safe-stored, the Offer Manager (1100) manages the activities of supplying filtered offers to Marketplace Matching (1200). Filtering of offers may include selection of offers on the basis of the offer state (e.g. in state open), upon the basis of matching for location, service types, and other parameters. The filtering steps optimize the Marketplace Matching component (1200) operation by limiting the number of offers that are processed by the Marketplace Matching component (1200). The Offer Manager (1100) also maintains information about service Provider entities and their associated Provider agent components (2000) associated with them. This information is kept in a Provider DB component (1140). The Provider DB component comprises well known storage systems, such as a file or DBMS system, and used by the Offer Manager (1100) in filtering, normalizing and sourcing functions.

The Offer Manager (1100) also cooperates with the Sourcing Manager (1550) to manage sourcing activities in order to increase liquidity of the market by identifying potential Providers and soliciting them to make offers that may be matched with orders (4030). Sourcing may be performed internally, using existing Providers recorded in the system (e.g. in the Provider Database (1140)), and/or by externally sourcing (1550), during which additional service Providers from outside sources are identified and incorporated into the system. Both types of sourcing occur on an as-needed basis.

### 5.4.3.1.1 Offer History Manager (1440)

The Offer History Manager (1440) component provides an interface between Providers and their offers, the contracts manager, and maintains historical information about offers that have been processed by the system. The Offer History Manager (1440) also maintains statistical information for use in sourcing and reporting operations, as well as reputation calculations, and for future reference. The Offer History component utilizes the same or similar storage mechanism as the Provider Database (1140) to store offer history information.

### 5.4.3.1.2 Service Profiles (1450)

Part of the system profile information the system maintains is profiles of services supported by the system. In simplest form, the service profile comprises a taxonomy of services and an ontology of service terms against which proposals may be matched for classification, and an ontology of inputs which are consumed by terms during classification. The service taxonomy is extended to include information about normalization of requests, such as the normalized terms and any required conversion factors to convert commonly used service descriptions to common terms during normalization. The service taxonomy defines, for each service, the price/unit measures that proposals referencing each service should be normalized to. These definitions enables the proposal normalization functions described below.

The system extends the service profiles to include demographic and location information, such as “the average lawn size in a particular neighborhood is 15000 square feet”, or the “average lawn size in a particular neighborhood is 60% of the lot size.”

While some matching parameters are common to all service types, such as scheduling, other matching parameters can vary with the type of service being provided. This is handled using a templating system, with different templates for different types of service as defined in the service profile. For example, a general contractor service type might require parameters for whether a job is commercial or residential and new construction or remodel, while paving services might require parameters for material to be used (asphalt, concrete, or gravel) and length of surface to be paved. Service-dependent templates define these parameters both for Consumer input of values and for use in matching Providers so that only Providers that can meet the requirements are matched. This avoids assigning a three person driveway paving company to a job that involves repaving 40 miles of interstate highway.

Lastly, the service profiles comprise definitions of how proposals, including general proposals and proposals for services at a particular service location, may be automatically enhanced. For example, a proposal that is mapped via the service profile to a normalized definition that requires lot square footage may be enhanced by searching past real estate listings to determine attributes of the service location (e.g. a large lawn, 5 bedrooms).

Optionally, a system profile-based ontology may be used to suggest categories for Providers to reduce any tendency for category duplication, and to assist Consumers in determining what category(s) relates to their task.

### 5.4.3.1.3 Provider Database (1140)

Information about service Providers and the Provider agent components (2000) associated with them is kept in a Provider Database component (1140). The Provider Database is implemented using a traditional storage mechanism, such as a file or DBMS system, and used by the Offer Manager (1100) during its filtering, normalizing, internal sourcing, and external sourcing functions, and by the Offer History Manager (1440) to maintain offer histories. In some implementations, the Provider database stores information about Providers, including:
Provider profiles
Cached reputation information about Providers

The Provider database also stores information about each offer from a Provider. This information includes:
Current offers (standing or special)
Historical offers (offers previously made)
Modifications to offers
Associations between offers and contracts

The Provider database may also include lists of standard offer requirements for specific Providers or classes of Providers for use in extending incomplete offers upon submission. Offer requirements include those described above for requests.

The Provider database may also store historical offer information for each Provider, including specific offer history and aggregate historical information (e.g. number of offers required, number filled), by service type, by service location (e.g. geographic region), by price bin, etc.

### 5.4.3.1.4 Provider Profiles

Providers who sign up to the system provide Provider profile information, including:
Contact information,
Initial reputation information (e.g. accreditations, associations (e.g. BBB), licenses, permits, bonds posted),
External ratings or references to ratings, such as D&B, credit ratings.
Categories of service that they provide, and their default unit pricing rate for each service they offer in the market.

Initial Provider reputation can also be added by the system, such as credit or business lien information, verification that the business is licensed or known by government agencies, time in business, etc. The reputation manager manages this process.

The Provider profile may also describe the services offered by each Provider. These services may be offered as a set (e.g. a licensed plumber can do the following things) or individually. Service offerings may be inclusive or exclusive. Inclusive means that the Provider is willing to provide the listed service, exclusive means the Provider is not willing to provide a listed service (e.g. I don't do windows).

Service offerings may also include selection criteria based upon size of job (e.g. I only take projects of this type that are larger than $5000). It should be noted that service offering specifications are changeable offering to offering, the Provider profile provides a template for offers from the Provider

Service offerings may also include demographic, location, or job site requirements. For example, a service Provider may include in their profile that they only want to work “in East Bay”, exclude specific neighborhoods, or exclude potential Consumers with particular demographics or attributes (e.g. willing to pay with PayPal).

If a service category is not present in the services profile, it can be added and used by a Provider by adding the service category to their Provider profile. The operators of the system may assist with rationalizing the request with the taxonomy, and may include the new service category in the system taxonomies.

Providers can optionally provide social networking information, such as Facebook or Twitter accounts, information such as email addresses about friends, family or others in their social network, or in-system IDs to enable the system to build a social connections graph for each Provider. Cached copies of the social graph may be stored in the profile, or recomputed on demand. The Provider profile also maintains a service history for the Provider, including all past proposals and their outcomes.

The Provider Profile may further comprise trust relationship information. This information identifies participants and/or social network members that a Provider relies upon for feedback or to limit the scope of their offers. For example, a Provider may indicate that Consumers who have worked for another provider, whose opinion they are willing to rely upon, should be given additional reputation weight for their offers, or that they recommend that provider to other participants who rely upon their opinion. Additionally, a Provider may establish trust with one or more Consumers explicitly by adding them to their recommended list of customers, or implicitly by working for a Consumer and expressing that they would work for that Consumer again. In each of these examples, a Provider may limit the trust information to one particular service category that they operate in or express the trust relationship as spanning a multiplicity of services.

### 5.4.3.1.5 Sourcing Manager (1550)

Sometimes, there is an insufficient number of compatible participants to make an effective match for an proposal. In this event, the system can automatically respond by attempting to recruit additional participants or request current participants submit additional proposals. These activities are coordinated by the Sourcing Manager (1550). These activities comprise recruitment of new participants as well as recruiting existing participants to submit proposals in additional categories. Recruitment of participants may also be performed using crowd-sourcing methods, such systems as Amazon's Mechanical Turk, web crawlers, search engines, automatically placing electronic or other advertisements, or simply by making requests to existing participants for suggestions and recommendations.

Internal sourcing is a process by which the Sourcing Manager (1550), upon recognizing that there are insufficient proposals of a specific type in the system, initiates contact with existing participants and identifies the types of proposals requested. The steps of identifying that there are insufficient proposals under management by the Sourcing Manager (1550) may be performed on a periodic basis, as-needed by the matching process, or when demand forecasting suggests that there will be an upcoming need for proposals for a particular service or set of services.

External sourcing is a process by which the Sourcing Manager (1550) identifies additional participants who may be induced to submit proposals. External sourcing activities can use services provided by the Reputation Manager (1500) to identify potential participants.

In one implementation, the Sourcing Manager (1550) is notified by the Marketplace Matching (1200) component that proposals to fulfill a particular service are required. The SourcingManager (1550) receives this notification and begins a sourcing process of internal and external sourcing in order to induce participants to submit proposals that match the outstanding orders.

In an alternative implementation, the Sourcing Manager (1550) may, on a periodic basis, review the list of current proposals and compare these proposals against historical or statistical proposal requirements, and if there is any current shortfall, begins a sourcing process of internal and external sourcing. For example, the Sourcing Manager (1550) may maintain a list of a minimum number of standing proposals to fulfill proposals for particular service in a geographic location, such as “toilet replacement in the East Bay” or “lawn mowing in Chestnut Hills”. If the number of standing proposals falls below this minimum threshold for proposals in the system, the system initiates a sourcing process in order to generate liquidity to the system.

In still other alternative implementations, the Sourcing Manager (1550) may forecast proposal demand based upon historical or statistical proposal requirements, and may begin a process comprising internal and/or external sourcing in order to have sufficient proposals on hand when expected proposals arrive. For example, when forecasts indicate an increase in demand (either trend or seasonal) such as the need for lawn mowing services during the summer months, the system may identify a scarcity of lawn mowing service proposals and initiate sourcing of lawn mowing proposals to fill the anticipated need.

### 5.4.3.1.5.1 Sourcing Process

FIG. 6 is a flowchart describing the steps of an exemplary method for participant sourcing. When invoked, the method first checks to see if the market has an imbalance (5010); that is, there are not enough proposals that match. If there is no imbalance, that is, a sufficiency of all existing proposals to be matched, the process is complete, as participant sourcing is not required.

If there is an imbalance (“yes” decision from 5010), a method of correcting the imbalance is selected (5015). This involves selecting one or more methods of increasing liquidity in the market by inducing participants to submit proposals to the system, or by inducing potential participants to join the system and submit proposals.

In a first method of increasing liquidity, an attempt is made to adjust existing proposals so that additional matches occur. The adjustment process is performed by identifying non-matching proposals and notifying the associated participants of potential adjustments that might be made in order to permit their proposal to be matched with other proposals (5020). The solution matrix from the matching process identifies those proposals that are close to match and further identifies the terms that might be adjusted in order to facilitate a match occurring. The use of solution results provides the system immediate data from which to construct feedback to participants on how their proposals fared and to suggest possible proposal adjustments to make their proposals more effective. This is an advantage over other market techniques which require separate searching or are unable to describe to participants actions that they can take to adjust their proposals so they match. Proposed adjustments may be to any proposal term or instructions, including price, schedule, location limitations, or other aspects of the proposal that are causing the proposals to not match other proposals in the system. For example, a Provider may be more willing to work outside of a preferred area than to lower pricing, or may be willing to work outside of normal hours in order to get some additional work rather than to travel farther. Permitting such adjustments to be made automatically can be permitted on a participant by participant basis, as defined in the participant profile. Alternatively, participants can adjust proposals manually, or create custom proposals on a case-by-case basis. Participant preferences in some implementations can comprise alternative terms, instructions, and/or weighting factors for calculating automatic adjustments to proposals. In other implementations, the participant's agent modifies and resubmits a proposal to make the change in terms or instructions.

In a second method, participants who have previously been matched for similar proposals are solicited (5040). This method is accomplished by searching the Order and Offer history databases, along with the contract databases. This search determines participants who have previously been matched with similar proposals, and then filters the resulting list of participants based upon instructions and terms of the potentially matching proposals. The resulting list of participants is then solicited to submit proposals with specific characteristics. These characteristics may be general (e.g. for a particular service) or detailed (e.g. for a particular service, at a particular geographic area).

Similarly, if a participant is identified as the target for sourcing, but does not have a proposal that might match already in the system, that participant is solicited to submit a proposal. Further consideration can be given to ensure that a participant has calendar time available over some duration to ensure that the solicited proposal has a high potential of filling the short term liquidity need.

In a third method, participants who have previously submitted proposals for the requested service are solicited (5060). This captures those participants who have previously provided or purchased that particular service in the past. This method is accomplished by searching the respective Order and Offer History databases to determine participants who have submitted similar proposals in the past. The resulting list of participants is then solicited to submit proposals with specific characteristics (e.g. for a particular service, at a particular geographic area).

In a fourth method, participants who have submitted proposals for similar services are solicited (5080). This captures the case when there are not enough participants submitting proposals for particular in-demand services. It identifies services for which there is insufficient liquidity, and identifies equivalent and/or related services using the normalization ontologies in service profiles. For example, the system may have a request to change a toilet, and has no proposals for toilet changing, but has a general plumbing service offered. The system uses the ontology to recognize that changing toilets is a service that can be provided by someone who performs general plumbing services, and may solicit a provider who has submitted offers to provide general plumbing services to provide an explicit proposal to change a toilet.

In a fifth method, participants who might be matched based upon their profile information, but who have not yet completed a registration processes (e.g. provision of required information, background checks, credit checks, proof of licensure, etc.) are solicited to complete registration (5100). These participants are identified by the filtering and scaling activities of the system, and may be directly solicited to complete registration activities so they can participate in the market.

In a sixth method, external sourcing is conducted (5120). External sourcing involves contacting potential participants who have not yet joined the Service Marketplace (100) and inviting them to join the marketplace and participate. Identification of potential participants can come from a variety of sources, such as recommendations from existing participants, traversal of existing participants' social graphs, enlisting crowd sourcing from services such as Amazon's Mechanical Turk, public directories such as yellow pages or ThomasNet (http://www.thomasnet.com), paid directories such as Angie's List, or web searches using search engines (e.g. Google.com, Lycos.com, dogpile.com, etc.). Potential participants may also be identified by soliciting existing participant recommendations and other crowd-sourcing techniques, and by collecting information using advertising campaigns.

One innovative aspect of the system, is the use of known and observed rates of response—qualitatively, quantitatively and with respect to time—to each of these mechanisms as part of the selection process (5015). For example, if it is known that there are already a large number of participants in a service category, but either relatively few outstanding offers or offers that have matching potential, it is advantageous to source offers from existing participants as this may be a quicker process to overcome short term liquidity problems. Additionally, the selection process (5015) can use this knowledge to parameterize and control the sourcing processes which it selects, such as the number of new participants desired from a external sourcing activity or the number of desired clicks in a digital marketing campaign, both of which can be selected based on the knowledge of the ratios of participation to proposal opened on the exchange.

In each case, solicitation for changes is performed by steps 5210 through 5230, comprising identifying solicitation candidates (5210), if none were identified (5220), returning without solicitation, otherwise soliciting the identified candidates (5230) before checking to see if additional liquidity is required (5010).

### 5.4.3.1.5.2 Offer Receipt and Processing

Newly received offers (4010 and 4020) are received at the offer receiving interface, verified by one or more verification processes to ensure completeness, normalized by an Offer Normalizer component (1120) as described below, and then are stored by an Offer History (1130) or Provider database (1140) component. Stored offers are then made available to the Marketplace Matching component (1200) for market operations as required, and may be filtered using the offer filtering component (1110).

The Offer Receiving interface(s) provide mechanisms by which offers may be received from Providers by the system. There can be one or more interface(s), depending upon implementation. Examples of receiving interfaces include participant interfaces such as web interfaces or application components that interface with the Offer Manager (1100) component, procedural interfaces such as RPC or SOAP, or messaging interfaces such as those provided by email or the MQ Series of messaging applications.

The Offer Manager (1100) then validates the offer. This step includes mechanical validation of offer fields, such as ensuring that services and locations listed in the offer are correct and valid.

### 5.4.3.2 Order Manager (1400)

The Order Manager (1400) component is responsible for receiving and initial processing of Orders (4030) supplied by Consumers (3000), and for supplying processed orders to Marketplace Matching components (1200) of the system. Newly received orders (4030) are extended and normalized by an Order Normalizer component (1410) as described below, and then stored in an Order Store (1420) component, such as a file or DBMS system, for future reference. The order store may be implemented as part of a more comprehensive customer database, or may be a stand-alone database. The customer database also stores Customer Profiles. A History component (1430), uses an underlying storage mechanism, such as a file or DBMS system, to store transaction history data, such as order input time stamps, order changes, and related information. The Order Manager (1400), supplies responses (4000) of various types to Consumers (3000) as needed, such as when an order is accepted, when an order is rejected, when data about order history is requested, etc.

### 5.4.3.2.1 Consumer Profile

Consumers who sign up to the system develop a Consumer profile. This profile includes information provided by the Consumer, e.g. a means of being contacted (e-mail preferably, but optionally home or mobile phone numbers, fax numbers, postal addresses, etc.), and possible service locations. They can optionally provide social networking information, such as Facebook or Twitter accounts, information such as email addresses about friends, family or others in their social network, or in-system IDs to enable the system to build a social connections graph for each Consumer. Cached copies of the social graph may be stored in the profile, or recomputed on demand. The Consumer profile also maintains a service history for the Consumer, including all past proposals and their outcomes.

The Consumer Profile may further comprise trust relationship information. This information identifies participants and/or social network members that a consumer relies upon for feedback or to limit the scope of their orders.

Consumers build reputation over time, based on payment history, the number of times the system has been used to find a Provider, and, optionally, on Provider ratings (“I would work for this Consumer again/I would not work for this Consumer again”, “project was a specified/project was not as specified”). Initial Consumer reputation can be based on data collected by the system, such as credit rating, bankruptcy information, or other publicly available data.

Finally, the Consumer profile comprises the selection criteria for service Providers (e.g. I only want Providers who are rated “I'll use them again” by my friends, or “I only want to consider Fred or Bob to do this project”). For example, a Consumer may connect with a friend whose feedback about Providers they are willing to rely upon or use to augment their belief in the Provider's reputation. A Consumer may also explicitly establish trust with one or more Providers by adding them to their list of recommended (or conversely blocked) service providers, or implicitly by completion of a job and whether they would continue to work with that provider.

### 5.4.3.2.2 Order Normalizer (1410)

The order normalizer component (1120) extends and normalizes proposals it receives by transforming the received proposal to use “normalized” terms, and by extending the proposal to include additional information. Normalization converts the proposal information into metrics that may be automatically compared by the marketplace matching component. Extension adds information available from historical and external sources to the proposal in order to provide additional information for filtering, normalization, and matching functions.

### 5.4.3.2.2.1 Normalization of Orders

To enable pricing for services to be compared, the idea of “unit pricing” is used. The units used are selected based on the type of service involved. For example, taxi services might use a unit of “miles”; babysitting, HVAC or plumbing services might use “hours”; hauling services can be rated in “tons”; roofing services can use “squares” (i.e. 10′×10′ areas of roof); and dog walking services use units of “dogs”. Materials costs may be internalized (i.e. composed into the unit pricing rate), externalized (i.e. “cost plus”, wherein the plus does not factor into the unit price), or factored (i.e. multi-party transaction) based on the service definition. For example, an auto garage may have a fixed unit price for oil changes or tire repairs, based on the average materials consumed in performing these services, while a kitchen remodeling company can have a unit cost in hours, to cover known labor costs, with materials (cabinets, lights, etc.) done as “cost plus”, with a cost based on what the Consumer wants installed. Unit pricing permits the system to compare service Providers and determine which are comparable in pricing when price is a factor in selection. Participants define, as part of their profiles, the information that they wish to receive from the marketplace feeds. They may use this information from the marketplace on unit pricing rates, possibly crossed with quality of service, reputation, or other factors, to see where a given participants proposal falls in a given category (high, low, typical). Such information can also be useful in determining whether to move a business to a new location. The relationship between unit price charged and reputation can also be an incentive for participants to work on keeping their reputation high.

### 5.4.3.2.2.2 Extension of Proposals

Automatic extension of proposals may be performed as part of normalization and extension to provide additional information about the proposal. Proposal extension attempts to “enhance” the proposal by providing additional information about the proposal to facilitate the matching and/or approval process. Proposals are typically enhanced using additional information about the market participant, previous proposals, or by obtaining additional information about one or more aspects of the proposal and including that information with the proposal. For example, a proposal may be extending using information related to:
reputation and attributes of Consumer's profile,
previous instances of an order, e.g. this proposal description was previously used to create an order by a Consumer, and the Provider rated the description for that order as accurate (or inaccurate),
external information, such as lot size or number of bedrooms from real-estate records,
demographic, including subdivision, location, etc. based upon service location. “Houses in this neighborhood average 2000 square feet in size”.

### 5.4.3.3 Contract Manager (1300)

The Contract Manager (1300) manages contracts, including creating contract documents, recording contract agreements in a History (1320) component such as a file or DBMS system, storing past contracts in a Contract Storage component (1310), such as a file or DBMS system, for future reference, and tracking payments for completed contracts, or contract milestones with a Payment Manager (1330) component. The Contract Manager (1300) supplies responses (4000) as needed to Consumers (3000) and Providers (2000), such as for notification of contract acceptance, acknowledgement of payment, or when contract details are requested.

The Contract Manager (1300) component also provides summary information of contract manager operation to the Marketplace Feed (1700) component.

### 5.4.3.4 Marketplace Matching (1200)

The Marketplace Matching (1200) component is responsible for matching orders to offers such that the requirements of each are met. Matching may be weighted by various factors, and need not be exact matches in order to be considered a match. The matching process determines the “best match” across many aspects of the proposals. This improves the quality of the match over traditional market mechanisms that focus on matching price. Details of the matching process are described below. When a match between one or more order(s) (4030) and offer(s) is found, the matched proposals are delivered to the Contract Manager (1300) for processing.

The system uses a matching function as part of the matching process. This function combines inputs and terms from potential proposals with historical data from the operation of the market and other aspects of the system and other synthesized factors as defined for each of the proposals.

The matching function may use weighting factors, as provided by profile items such as preferences and information provided by the Provider agent component such as a Provider's current availability, location, and schedule, and Consumer-specified profile items such as the location of the Consumer work site, Consumer reputation, etc. to direct the matching process in order to increase the chance of a match. For example, if the Consumer's schedule wants an immediate start (e.g. Consumer needs a plumber because pipes have burst), preference can be given to Providers that are currently located near the Consumer's work site, and not already engaged.

Another aspect of the matching process is the use of weighting factors supplied by the market participant. For example, priority factors can be specified to indicate what is most important to the participant. These may include one or more aspects such as:
best reputation,
best schedule fit,
nearest to current location
lowest per unit cost, or
lowest projected total cost.

Participants can indicate in a proposal which weighting factors to employ for a given request, and how much relative weight to assign to them. Default values can be set in a respective participant profiles, and are typically provided in a category template.

Thresholds can be used as “go/no go” selectors for matching proposals. Either a counter proposal meets a set of requirements, or they cannot match. Thresholds can include aspects of the proposing entity and/or the proposal itself. For example, a threshold could require that an entity is licensed, or have performed a minimum number of jobs in the system. More information on thresholds requirements that may be associated with proposals are described above as part of the proposal terms and instructions description.

Another aspect of the matching process is the use of weighting factors defined by the marketplace itself. These weighting factors balance the marketplace utility function over time. They may also be used to limit the range of variability for order or offer weights. For example, a Consumer may express that it is very important to have a service Provider that is creditworthy. However, to avoid this term dominating the relative weight of this factor, the market can apply its own weight to limit its impact.

Two possible methods for performing matching with the above criteria are to treat the problem as a statistical optimization problem or as a general constraint problem. Both methods are well understood in general. Dynamic weighting can be added to this to adjust matching based on current or historical market factors, such as the number of Providers of a given service in the system who are not already scheduled for the required time period, price fluctuation or decay limits, or quantities of current matches versus historical norms.

In some cases, matching is not needed to locate a proposal, but only to schedule work. For example, a satisfied Consumer can select a completed transaction (or even a new request) for repeat business (e.g. ad-hoc future work or a scheduled recurrence). A Consumer can single- or multi-source orders (i.e. specify one or more specific Providers that can be matched), which can be treated as a form of reputation requirement. This is referred to as “in-sourcing”.

### 5.4.4 Pricing Terms and Pricing Function.

Every proposal is associated with a pricing function during matching. The pricing function defines a combination of factors, including reputation, schedule, number of completed contracts in the system, price, etc. When taken as a whole, the terms of an proposal can be represented as a pricing function, oᵢ(t)=f(rep, price, schedule, . . . ). This function can be estimated as a linear function of constant weights and variable inputs, oᵢ=aᵢx+bᵢy+cᵢz . . . . Each term can be thought of as a weighting factor λᵢ for a variable input vᵢ which has been normalized to have a unit representation (a real value in the interval [0,1]). For example, a Consumer credit score is a whole number from [0,1000) and can be normalized simply by dividing it by 1000. A more complex normalization might be to recognize that a credit score is a Gaussian distribution centered on 690, and normalize the score to spread the results across the unit range. The weighting factor applied to the term is a combination of defined scale factors and ranges or presets which a Consumer can adjust.

### 5.4.4.1.1 Proposal Matching

The system continuously attempts to match proposals in accordance with the terms supplied, while simultaneously maximizing benefit to all participants of the market. We can then take each set of proposals (e.g. offers and orders) independently and match it to its complement, each order having a unique function which is computed against each and every offer, and vice versa. This produces two sets of linear equations representing the relative value of all matches.

$${M}_{ij} = [ \begin{matrix}{a}_{0} & {b}_{0} & {c}_{0} \\ … & … & … \\ {a}_{i} & {b}_{i} & {c}_{i}\end{matrix} ] \times [ \begin{matrix}{x}_{0} & … & {x}_{j} \\ {y}_{0} & … & {y}_{j} \\ {z}_{0} & … & {z}_{j}\end{matrix} ] and$$

$${M}_{ji} = [ \begin{matrix}{a}_{0} & {b}_{0} & {c}_{0} \\ … & … & … \\ {a}_{j} & {b}_{j} & {c}_{j}\end{matrix} ] \times [ \begin{matrix}{x}_{0} & … & {x}_{i} \\ {y}_{0} & … & {y}_{i} \\ {z}_{0} & … & {z}_{i}\end{matrix} ]$$

The proposal matching procedure solves this set of equations to identify sets of proposal (i,j), such that each selected set achieves the desired market terms and optimization criteria. The largest number in any row, for example, represents the best theoretical matching offer for that order. Criteria such as limiting only one offer to match one offer are expressible as cardinality constraints against the rows and columns of the matrices.

### 5.4.4.1.1.1 Numericalization

The pricing function concept requires that each term be represented numerically. A priority expression such as “price is more important than reputation” is reduced to a set of relative weights. This resultant weight is a combination of both intrinsic scaling, Sᵢ, and Consumer or Provider modifiers, Cᵢ. This allows the control the general matching capabilities of the system, with fine tuning provided by the order terms.

aᵢ=Sᵢ·Cᵢ

### 5.4.4.1.1.2 Normalization of Quantities and Scale Factors

The relation between terms in the value matrix is extremely important, as the proportion represents the quality of the potential match between order and offer. To preserve that relation, the quantities and scale factors have to be normalized. If we consider any one pricing function as a unit vector:

v(t)=aᵢxᵢ+bᵢyᵢ+ . . . ≦1

From this, we can assert that any one term must also be less than or equal to one, and therefore any scale factor must also be less than or equal to one. For example, if we have a series of weights, they must be normalized to one.

$${a}_{i} = \frac{{S}_{i} \cdot {C}_{i}}{\sum {a}_{i} + {b}_{i} + {c}_{i}}$$

Similarly, variable inputs must also be scaled. In the example presented earlier, a Consumer's credit score can take on values up to 1000. As an input, it should be scaled by dividing the actual score by that maximum value.

$${x}_{i} = \frac{{x}_{i}}{max ( x )}$$

### 5.4.4.1.1.3 Marketplace Utility Function

While solving for matching proposals, one final function is applied that alters proposal weighting and determines whether a match identified by the solver should be accepted or postponed. This is called the marketplace utility function. The function measures the benefit of the potential match to the marketplace and whether the marketplace is performing in a mutually beneficial manner. A mutually beneficial marketplace is one in which the Provider's revenue generates profit and positive Consumer surplus—e.g. that the Consumer paid less than the maximum amount he was willing to pay. The marketplace utility function also measures whether the marketplace is advantaged by performing a “greedy match” of proposals, or whether factors such as liquidity indicate that it is probable that a more advantageous match is likely to present itself before a match must be declared. In short, the marketplace utility function implements a novel “wait and see” approach to matching in varying liquidity environments where additional potential matches may occur if the match is delayed.

The marketplace utility function operates by considering a set of proposals that have been identified by the matching function, e.g. order and offers. The set of orders is called O, and these separate set of offers is called B. The i-th order can be represented by oᵢ the maximum price/budget allocated to the order by a Consumer. The j-th offer, bⱼ is the minimum project size a Provider is willing to accept, broken down into its cost cⱼ and minimum profit margin gⱼ. For any potential match between proposals, tᵢⱼ reflects the price of the match. The value to the Consumer is then, vᵢ=oᵢ−tᵢⱼ, and the value to the Provider, vⱼ=tᵢⱼ−bⱼ. The value to the market itself is in proportion to the commission or fee structure associated with a match. In a simple case where the market solely charges a percentage of the final service price, m, the value to the market is vₘ=m tᵢⱼ. Accounting for commissions charged only to the service provider, the provider value can be restated as, vⱼ=(1−m)tᵢⱼ−bⱼ.

In other terms, the expected value of the marketplace's current state is,

$${E}_{t} = {\sum }_{i , j} {p}_{ij} \cdot {t}_{ij}$$

where pᵢⱼ is the conditional probability that the i-th order matches the j-th offer. From this it follows that the expected utility to the participants can be shown,

$${U}_{i} = {\sum }_{i} {o}_{i} - {E}_{t} , {U}_{j} = ( 1 - m ) {E}_{t} - {\sum }_{j} {b}_{j} , {U}_{m} = ( 1 - m ) {E}_{t}$$

Even though the market through its matching function, defines which combinations of proposals represent the best matches at any one interval of time, the marketplace utility function defines a continuous-time, stochastic process where the matching process operates over an infinite time series of proposals, further considering these defined utility metrics to be functions over time, U(t). When time is considered, the goal of the utility function is to maximize utility to its participants over the life of the market versus any one specific interval and indicates when time delay of matching may be appropriate. The marketplace utility function modifies the matching to maximize the benefit of the match to the marketplace by maximizing the expected value of the marketplace and its participants' utility.

Using a Kalman filter or other stochastic predictor such as a Bayesian estimator the system models the current and predicted behavior of proposals. For example, proposal submission can be viewed as a Poisson process, with a measurable frequency and decay of inter-arrival times. Based on observed behavior, the system estimates whether it is likely that one or more new proposals will be submitted within the time frame of prediction. A further prediction is made as to the relative composition of those proposals and hence their match probabilities against the currently known set, and the confidence or accuracy of the predictions.

During each interval that processing occurs, the system determines the set of matches based on its predictions, by optimizing for the utility produced by potential matches over the time window of its current processing through the range of future predictions. If a match exists between two proposals which are from its real order and offer inputs, the match will be reserved in the current round. If the best match is found by pairing and order with a future synthetic offer, for example, that fact is stored in the history of the estimator, but no actual match is made, even if a match does exist between the order and a current offer.

### 5.4.4.1.1.4 Solving

Now we are left with the heart of the problem. How do we use all of this information to find the best set of matches? Two possible formulations are as a mathematical optimization problem or as a general constraint problem. As a linear optimization problem (as described above), the system takes the two sets of equations and solves for a transformation matrix which maximizes the expected utility and transaction volume.

In practice, the inclusion of scheduling, routing and other constraints significantly increases the set of decision variables making the problem better solved using general optimization techniques. If we reformulate the problem, accounting for scheduling constraints, we can define it as follows:

Let E be a set of entities, A be a set of orders and B be a set of offers.

Let P={<a,b>:aεA, bεB and a satisfies b} be the set of potential pairings.

∀<a, b>εP let S_{a,b} be the set of satisfying schedules for the pair <a,b>.

∀sεS_{a,b} let T_{s,a,b} be the discrete time interval representation of schedule s.

Let p_{s,a,b} be the preference of matching order a to offer b using schedule s.

Let capacity_{ε,i} be the capacity of entity e at discrete time interval i.

Let Fₑ be the set of discrete time intervals over which entity e is available.

∀₀εA∪B, eεE,

$$let {creator}_{e , o} = \{ \begin{matrix}1 \text{:} e owns o \\ 0 \text{:} owise\end{matrix} \\ let {r}_{e , o} = \{ \begin{matrix}1 \text{:} satisfaction of o reserves capacity of e \\ 0 \text{:} owise\end{matrix}$$

Variables:

Let x_{s,a,b} be the binary decision variable pairing order a and offer b using schedule s.

Let u_{s,o,t} be the binary decision variable indicating reservation of proposal o at time t to satisfy schedule s.

Constraints:

Entity capacity: ∀eεE, ∀tεF [symbol] , Σ [symbol] Σ_{oεA∪B}creator_{s,o}×r_{e,o}×u_{s,o,t}≦capacity_{e,t}

Schedule availability: ∀<a, b>εP, ∀sεS_{a,b}, ∀tεT_{s,a,b},

x_{s,a,b}−u_{s,a,t}=0

x_{s,a,b}−u_{s,b,t}=0

Proposal satisfaction:

∀aεA, Σ_{bεB}Σ_{sεS}_{_{a,b}}x_{s,a,b}≦1

∀bεB, Σ_{aεA}Σ_{sεS}_{_{a,b}}x_{s,a,b}≦1

Goals:

maxΣ_{aεA}Σ_{bεB}Σ_{sεS}_{_{a,b}}x_{s,a,b}

maxΣ_{aεA}Σ_{bεB}Σ_{sεS}_{_{a,b}}p_{s,a,b}×x_{s,a,b}

Alternately, the system can treat one pass of the proposal matching process as a constraint satisfaction problem, or CSP. Each proposal term represents a constraint or an optimization instruction. The system then utilizes one of many well-studied, search-based solving algorithms as the core of the matching engine. As a further layer to the engine, the system augments the core CSP with dynamic weighting (or even changes to the problem formulation) based on historical observations of the market performance.

### 5.4.4.2 Reputation Manager (1500)

The Reputation Manager (1500) component deals with reputation and relationships between Participants. Reputation data can be used to weight, prohibit, or mandate matching of proposals between participants, for purposes of adjusting payment terms, for recommendations of Providers or Consumers, or for other purposes, such as enticement offers or rewards systems.

Reputation encompasses relationships between participants both within, and without the Service Marketplace, such as those indicated by such things as “friending” on Facebook, being in the same network on Linked-In, or one participant sourcing another into the Service Marketplace (100). The Reputation Manager (1500) comprises components such as zero or more Social Net Managers (1520), each of which tracks connections between participants in its own way, and stores the related data in a storage component (1525), and zero or more Third Party Interfaces (1510), each of which is used to obtain data from a different external source, such as a credit bureau, background check system, state corporation data website, etc.

The third party interfaces (1510) further comprises methods for integration of the Service Marketplace with external services, such as social networks (Facebook, Google+, etc.), third party verification systems (Dunn and Bradstreet, Better Business Bureau, government licensing agencies, etc.), or financial institutions (automated payment systems, ACH, credit card accounts and merchant services, etc.) These methods of verification are well understood by those skilled in the art.

### 5.4.4.2.1 Verification of Provided Information

While the system does not rate Providers or Consumers, it does attempt to ensure that participants of the system are who they say they are, to prevent scamming the system. For example, the system prevents a Consumer or Provider with a poor reputation from escaping the consequences by creating an alias and signing up again. Verification can involve use of credit card numbers, credit rating checks, verification of state licenses, checks of mailing addresses, etc. Verification is intended to prove that an individual or Provider is who they claim to be, nothing more.

Most people are honest, but some are not. The less honest folks might use the system to find a Provider, but then go off-system to complete the transaction, eliminating the transaction fee to the system. The system provides useful functionality for completing transactions, which encourage participants to use the system to complete transactions. For those participants that don't complete their transactions using the system, the system can use history and statistical methods to detect those participants who have a pattern of not completing transactions (e.g. that are abusing the system). For example, if a Provider is matched with a number of Consumers who then do not request re-matching, but who also do not complete the transaction, and this is statistically different from the experience of most Providers of that category of service, it can be assumed that the Provider is completing at least some transactions off-system. Response to this can range from warnings to increased fee percentages, to expulsion from the system.

Further, the system discourages “shilling”. One mechanism used to inflate reputation in existing systems is the creation of fake personalities to provide explicit feedback which can alter the weighting used by the system. As noted above, fake personas are guarded against within the system. Further, the use of numerous small transactions as a way to pump up positive feedback can be detected as the pattern will be outside of the norm for the category.

### 5.4.4.3 Notification Manager (1600)

The Notification Manager (1600) is used for notification of participants when significant events occur, such as orders, offers, acceptances, contracts, service completions, and payments. Other Service Marketplace (100) components use the Notification Manager (1600) to convey notifications by whatever means is preferred by individual participants, such as e-mail, SMS text messages, web page interactions, postal mail, voice interactive telephone calls, TTY services, IM services, etc. The Notification Manager (1600) in some implementations may record acknowledgement of delivery of notifications, use alternative means when the preferred means is unavailable or unsuccessful, use a plurality of means for a given notification, and/or store notifications for future reference.

### 5.4.4.4 Marketplace Feed (1700)

The Marketplace Feed (1700) component is used to provide a continuous feed listing market operations and results. It draws information from the Offer Manager (1100), the Order Manager (1400), and the Contract Manager (1300) components. This information is provided to information subscribers on an as-requested basis.

### 5.4.5 Consumer Agent Components (3000)

FIG. 7 is a diagram showing some of the aspects of an exemplary configuration of Consumer components (3000). These include at least one participant interface for interaction with the Consumer, zero or more Proposals (3010), a Calendar or scheduling component (3020), a set of constraints, preferences, and templates (3030) stored as part of a Consumer Preferences component, and a Consumer History Storage component (3040).

Service Requests (3010) are entered by a Consumer to request a service. These are converted into orders (4030) by associating them with order terms, such as scheduling constraints, cost limitations, provider preferences, quality of service requirements, etc., and submitting the order to the an Order Manager (1400) of a service marketplace.

Calendar (1135 and 1435) or scheduling components (3020) are used to record and track events such as order submissions, contract start dates, contract completion dates, etc. as well as to determine available dates for service work to be performed.

Constraints, preferences, and templates (3030) comprise information used in converting service requests (3010) into orders (4030). They can comprise preferred times of day for service to be performed or phone calls to be received, default locations, thresholds for selection of Providers, factors to use in weighting selection of Providers, standard service request templates for services that a Consumer requests frequently, etc. Each fields in associated with requests may be stored as part of the preferences and templates.

The Consumer History Storage component (3040) is used to store previous and current service requests (3010), interactions with Providers such as: order result messages (4040), contracts (4050), payment receipts (not shown), acknowledgements and approvals (4060), completion reports and evaluations (4070), etc.

### 5.4.6 Provider Agent (2000)

FIG. 8 is a diagram showing some of the aspects of a Provider Agent component (2000). These include at least one participant interface for interaction with a Provider, standard offer templates (2010), a Calendar (1135 and 1435) or scheduling component (2020), a set of constraints, preferences, and templates (2030), a Provider taxonomy (2040), and a Provider History Storage component (2050).

Standard offer templates (2010) are used in constructing offers (4010 and 4020). Templates can comprise offer text, terms of service, price ranges, scheduling limitations or requirements, job size limitations or requirements, and other criteria needed to match an offer with an order. Standard offer templates (2010) can vary by type of work, by Provider, by time of year, or by other factors. They permit a Provider to define offers ahead of time, so that standard offers specific to an order can be automatically generated as needed.

Calendar or scheduling components (2020) are used to record and track events such as offer submissions, contract start dates, contract completion dates, etc. as well as to determine available dates for service work to be performed.

Constraints, preferences, and templates (2030) comprise data used in converting standard offer templates (2010) into standard offers (4010). They can comprise times during which service can be provided, contact preferences and information, or custom templates for generating custom offers (4020), etc.

The Provider History Storage component (2050) is used to store previous and current offers (e.g. standard offers 4010 and custom offers 4020), interactions with Consumers such as offer result messages (4080), copies of contracts (4050), payment status (not shown), acknowledgements and approvals (4060), completion reports and evaluations (4070), etc.

### 5.4.7 Service Marketplace Processing

FIG. 9 is a flowchart showing the processing flow of a Service Marketplace (100) handling an order from a Consumer. The process begins when a Consumer enters a service request (3010) using a Consumer Agent component (3000) and it is converted to an order and transferred to the Order Manager (1400) component of the Marketplace Processing component (1000). The order is received (1010), normalized and extended by the Order Manager (1400), and passed to the Marketplace Matching component (1200). The Marketplace Matching component (1200) first determines filter parameters for the order (1020) using parameters from the order (4030) and other data, such as social network data provided by the Reputation Manager (1500).

Filter parameters are used in matching the order to Provider offers and can comprise such items as required work start dates, unit prices, job size, location of work, Providers that are eligible to provide the service based on allow/disallow lists, social network data, availability for the required work dates, rates, capabilities, or other factors. Using the filter parameters the Marketplace Matching component (1200) determines whether the order is fillable (1030). Orders may be found to be unfillable at this point; for example if there are no Providers of the ordered service participating in the Service Marketplace (100), or there are no Providers of the ordered service providing service in the requested location.

If the order is not fillable (1030), a check is made to see if the order has expired (1070). Orders can optionally be submitted with an expiration time. Orders not fillable prior to that time are cancelled, and the process is complete. If the order has not expired (1070), a delay may be imposed in some implementations (1080) before further processing is performed on the order.

The next processing step is an optional adjustment of the filter criteria (1090). Some implementations permit a Consumer to specify some or all order requirements as optional. If an order cannot be fulfilled as entered, some or all of the optional requirements can be removed or relaxed in an attempt to make the order fillable. For example, the order may have a preferred start date, but an optional range of start dates if the preferred date is not available. Other filter criteria that can be made optional include, but are not limited to, minimum quality threshold, maximum cost, social network proximity threshold, and whether materials are supplied by the service Provider or not. In some implementations the order in which filter criteria are adjusted in an attempt to find a match can be specified by the Consumer. In some other implementations filter criteria are weighted by the Consumer, the system, or a combination of both, and filter criteria with the lowest weight values are adjusted preferentially.

Some implementations implement an “extra sourcing” step, for example suggesting that a proposal submitter invite additional participants or desired counterparties, in an attempt to add Providers to the Service Marketplace. One or more of any added Providers may be willing to fulfill the order and make an order fillable.

Filter parameters are then determined again, to take into account any changes in filter criteria or Providers, and a check to see if the order is fillable is again made (1030). This process continues until the order expires (1070), or becomes fillable (1030). If the order is fillable, the Marketplace Matching component (1200) attempts to match the order with Provider offers (1040). If there is no match (1050), order expiration is checked (1070), and the other steps described above are performed until the order expires (1070) or a match is found (1050). When a matching offer is found (1050), it is confirmed (1055) and the matched proposals are committed (if permitted by time constraints) and a contract is produced (1060).

FIG. 10 is a flowchart showing an alternate exemplary process of matching an order (4030) with offers (4010 and 4020). The process begins by selecting possible matches based on filtering parameters and threshold values (1041). Pricing, reputation, and schedule requirements are determined and used to further filter the possible offers (1043). A decision problem is then constructed that includes weighting factors (1045) and the decision problem is then solved (1047) and the results solved for maximum utility (1049) to determine which offer is the best match to the order, or that the market should wait and attempt to match again based on the expectation of higher future benefit.

FIG. 11 is a flowchart showing the process used for a Consumer to contract for a service using a Service Marketplace (100). The process begins with the Consumer entering an order (3510). The matching process described above is performed to determine if there is a Provider offer that matches with the order. Notification of the results of this matching process are returned to the Consumer (3512). The results may be that there is no match, or that a match was found. If a match is not found, the Consumer can alter the order and resubmit it. If a match is found, the Consumer and the Provider making the offer exchange communications and either accept the match or do not accept (3514). If there is no acceptance (3514), the match is rejected (3515). If there is acceptance (3514), the contract details are sent to the consumer (3520) and the Consumer receives the service (3530), and submits an evaluation of the service provided (3540) and a report of completion (3540).

FIG. 12 is a flowchart showing the process used for a Provider to contract to provide a service using a Service Marketplace (100). The process begins when the Provider makes an offer to provide a service (2510). The offer can be a standard offer, or a custom offer. If the offer matches with an order, the Provider is notified of the match (2520), and decides whether to accept the order (2530). If the Provider decides not to accept the order (2530), a record is made in the Provider's history (2540) and the Marketplace Matching component (1000) attempts to match the order with another Provider as described above.

If the Provider accepts the order, a contract (4050) is generated and sent to the Provider (2550). The Provider then performs the service (2560), and reports completion to the Service Marketplace (2570). The Service Marketplace Payment Manager (1330) communicates as needed with the Provider and Consumer to arrange payment and the Provider supplies an evaluation of the Consumer (2580) to the Service Marketplace (100).

It will also be recognized by those skilled in the art that, while the marketplace has been described above in terms of various implementations, it is not limited thereto. Various features and aspects of the above described marketplace may be used individually or jointly. Further, although the marketplacehas been described in the context of its implementation in a particular environment, and for particular applications, those skilled in the art will recognize that its usefulness is not limited thereto and that the marketplace can be beneficially utilized in any number of environments and implementations where it is desirable to create a service marketplace.

We claim:

1. A computer system, comprising:
A computer server, further comprising:
a computer processor,
a first networking interface,
and at least one data store,
the computer system further comprising:
a first data store in which representations of fungible service offerings are stored,
a computer processor executable program, providing software programs that implement a first user agent, able to receive and convert user service offerings into fungible representations for stored in the first data store
a second data store in which representations of fungible service requests are stored,
a computer processor executable program, providing software programs that implement a second user agent, able to receive convert user service requests into fungible representations for stored in the second data store,
a third data store in which matched services and offerings representing a contract are stored,
a computer processor executable program providing a market maker service,
logically connected to the first and second data store,
comprising software instructions that implement a demand market for fungible services,
effective to match fungible service offerings to fungible service requests,
and producing contract representations comprising matched service offering/requests.

2. A computer system of claim 1, further comprising a computer processor executable program providing a contract signing mechanism, effective to digitally sign contract representations comprising matched service offering/requests from the market maker service, and storing a signed contract representation the third data store.

3. A computer system of claim 1, further comprising a computer processor executable program that implements a liquidity generation component for service offerings

4. A computer system of claim 1, further comprising a computer processor executable program that implements a liquidity generation component for service requests

5. A computer system of claim 1, further comprising a computer processor executable program that implements a contract management component, effective to manage the fulfillment of contract representations

6. A method of providing a fungible services market, the method comprising the steps of:
a. receiving service offerings from at least one user using a user agent,
b. converting the service offerings to fungible market service offering representations, and storing these fungible service offering representations into a first data store,
c. receiving service requests from at least one user via a user agent,
d. converting the service requests to fungible market service request representations, and storing these fungible service request representations into a second data store,
e. providing a market maker service, which performs the steps of:
i. reading service request and service offering representations from the data store(s),
ii. performing a market matching algorithm,
iii. matching two or more service request and offerings to produce a contract
iv. storing the contract in a third data store

7. The method of providing a fungible services market of claim 6, the method comprising the further steps of combining the matched fungible service requests and fungible service offerings and producing a stored contract representation.

8. The method of providing a fungible services market of claim 6, the method comprising the further steps of providing a liquidity generator configured for automatically soliciting providers for the purpose of increasing the number of fungible service offerings.

9. The method of providing a fungible services market of claim 6, the method comprising the further steps of providing a liquidity generator configured for automatically soliciting consumers for the purpose of increasing the number of fungible service requests.

10. The method of providing a fungible services market of claim 6, where the market maker service matches based, in part, upon predicted future service requests and offerings and not upon the current set of currently stored service requests and offerings.

11. The method of providing a fungible services market of claim 6, where the market maker service matches based, in part, upon fitness criteria set by each individual service request.

12. A method of providing liquidity to a fungible services market, the method comprising the steps of:
a. Identifying potential services offerers, by selecting among a plurality of methods to attract further requests and offering, either of which may scan a list of previous services requests and offerings and selecting previous participants who do not have a current fungible service offering in the system or automatically extending participation from outside of the system,
b. sending a solicitation for potential services offerers or requesters to submit service offerings and requests to the system
c. receiving one or more service requests or offerings from a potential participant,
d. Converting the service requests or offerings to fungible service request or offering representations,
e. Storing the fungible service request or offering representations in a data store.

13. A method of providing a market matching algorithm wherein each order and offer request are evaluated separately and against all others using a plurality of matching terms specific to each request, the method comprising the steps of:
a. Determining threshold criteria against which counter proposals cannot match,
b. Calculating the pricing, reputation, scheduling and other parameters of the requests,
c. Constructing a decision problem,
d. Solving the decision problem,
e. Evaluating the utility of potential matches based on the solved decision problem
f. Selecting zero or more matches based on the results of the evaluation.
